(19) United States
(12) Patent Application Publication
(10) Pub. No.: US 2024/0318086 A1
(43) Pub. Date: Sep. 26, 2024

(54) OIL PRODUCTION SYSTEM AND METHOD OF USING THE SAME

(71) Applicant: Renuva, Inc., Kaysville, UT (US)

(72) Inventors: Jason D. OWENS, Grantsville, UT (US); J. Stephen SAVAGE, JR., Kaysville, UT (US)

(21) Appl. No.: 18/583,506

(22) Filed: Feb. 21, 2024

Related U.S. Application Data
(60) Provisional application No. 63/447,469, filed on Feb. 22, 2023.

(51) Int. Cl. C10G 5/06; B01D 5/00; B01D 17/02

(52) U.S. Cl. CPC C10G 5/06; B01D 5/0027; B01D 17/02; C10G 2300/4006; C10G 2300/4081

(57) ABSTRACT

Disclosed herein is a system for producing oil from feedstock containing hydrocarbons. The system may include a first condenser that receives a vapor, which contains hydrocarbons. The first condenser may use a light oil to cool and condense a portion of the vapor into a heavy oil. The system may include a second condenser that receives the uncondensed portion of the vapor. The second condenser may use a light oil to cool and condense a portion of the vapor into a heavy oil and a mixture of oil and water. The system may include a separator to separate the light oil from the water. The light oil may be recirculated to the first condenser and the second condenser.

### CROSS-REFERENCE TO RELATED APPLICATIONS

This application claims the benefit of U.S. Provisional Application No. 63/447,469, filed Feb. 22, 2023, which is hereby incorporated by reference in its entirety into the present application.

### TECHNICAL FIELD

The present disclosure is directed to a system for producing oil. More specifically, the present disclosure is directed a system for producing oil from feedstock containing hydrocarbons.

### BACKGROUND

Retorts are substantially airtight vessels that heat a fossil fuel (or biomass) therein to remove particulate matter from the fossil fuel and provide a “clean” energy product. For example, coal may be heated in a retort. After sufficient heating, the fossil fuel gives off gaseous products that can be further processed. The fossil fuel itself may be cooled and further processed to produce a “cleaner” fuel product.

Accordingly, there is a need in the art for systems and methods of producing oil from feedstock that contains hydrocarbons that are efficient, reduce carbon emissions, and reduce the potential for contamination within the system. It is with these thoughts in mind, among others, that oil production system and method of use was developed.

### SUMMARY

Aspects of the present disclosure include a system for producing oil from feedstock containing hydrocarbons. The system may include a first condenser, a second condenser, and a separator. The first condenser may receive a vapor that contains hydrocarbons at a first inlet. The first condenser may receive a first portion of light oil at a second inlet. The first portion of light oil may cool the vapor. The first condenser may condense a first portion of the vapor into a first portion of heavy oil. The first condenser may discharge a second portion of the vapor at a first outlet and may discharge the first portion of heavy oil at a second outlet.

The second condenser is in fluid communication with the first condenser, and the second condenser may receive the second portion of the vapor from the first outlet of the first condenser at a first inlet of the second condenser. The second condenser may receive a second portion of light oil at a second inlet. The second portion of light oil may cool the second portion of the vapor. The second condenser may condense a third portion of the vapor into a second portion of heavy oil and a mixture of light oil and water. The second condenser may discharge a non-condensable portion of the vapor at a first outlet, may discharge the second portion of heavy oil at a second outlet, and may discharge the mixture of light oil and water at a third outlet.

The separator is in fluid communication with the second condenser, and the separator may receive the mixture of light oil and water from the third outlet of the second condenser at an inlet of the separator. The separator may separate the mixture of light oil and water into light oil and water. The separator may discharge the water at a first outlet and may discharge the light oil at a second outlet.

In certain instances, the system may include a tank in fluid communication with the separator. The tank may receive the light oil from the second outlet of the separator at an inlet. The tank may supply the first portion of light oil to the first condenser and the second portion of light oil to the second condenser from an outlet.

In certain instances, the first condenser may include a third inlet that receives a circulating fluid from a cooling unit. The vapor rejects heat and the circulating fluid absorbs heat in the first condenser. The first condenser may discharge the circulating fluid to the cooling unit at a third outlet of the first condenser.

In certain instances, the cooling unit may be a cooling tower, which may receive a cooling fluid. The circulating fluid rejects heat and the cooling fluid absorbing heat in the cooling tower.

In certain instances, the circulating fluid may be oil. The cooling fluid may be water, and the cooling tower may evaporate the water.

In certain instances, the first condenser may be configured to reduce the temperature of the vapor to between approximately 250-degrees Fahrenheit and 300-degrees Fahrenheit.

In certain instances, the first inlet located may be located near the bottom of the second condenser. The second condenser may include one or more spray nozzles within the second condenser and located above the first inlet. The spray nozzles may be in fluid communication with the second inlet, and the spray nozzles may receive the second portion of light oil. The spray nozzles may spray the second portion of light oil inside the second condenser. The second condenser may include a tray that receives and collects the mixture of light oil and water. The second outlet of the second condenser may be located near the bottom of the second condenser.

In certain instances, the second condenser may be configured to reduce the temperature of the second portion of the vapor to between approximately 200-degrees Fahrenheit and 249-degrees Fahrenheit.

In certain instances, the system may include a hopper, a feed screw, a retort, and a particle remover. The hopper may receive the feedstock at an inlet and discharge the feedstock at an outlet. The hopper may include a lid that removably seals the inlet of the hopper with respect to ambient air. The feed screw may be in communication with the hopper, and a first end of the feed screw receives the feedstock from the outlet of the hopper. The feed screw may supply the feedstock to a second end of the feed screw. A retort may be in communication with the feed screw, and an inlet of the retort may receive the feedstock from the second end of the feed screw. The retort may heat the feedstock until a first portion of the feedstock vaporizes into the vapor and a second portion of the feedstock is a solid mass. The retort may discharge the vapor at a first outlet and may discharge the solid mass at a second outlet. The particle remover may be in fluid communication with the retort, and an inlet of the particle remover may receive the vapor from the first outlet of the retort. The particle remover may remove particles from the vapor. The particle remover may discharge the vapor at an outlet of the particle remover, wherein the first inlet of the first condenser may receive the vapor.

In certain instances, the outlet of the hopper may include a valve to limit air flow through the outlet of the hopper. The inlet of the retort may include a seal to limit air flow through the inlet of the retort. The first outlet of the retort may include a seal to limit air flow through the first outlet of the retort. The second outlet of the retort may include a seal to limit air flow through the second outlet of the retort.

In certain instances, the hopper may receive a purge gas. The purge gas may include the non-condensable portion of the vapor.

In certain instances, the hopper may be in fluid communication with the second condenser, and the hopper inlet may receive the non-condensable portion of the vapor from the first outlet of the second condenser.

In certain instances, the system may include a gas flare. The gas flare may be in fluid communication with the second condenser, and the gas flare may receive the non-condensable portion of the vapor from the third outlet of the second condenser. The gas flare may be configured to burn the non-condensable portion of the vapor.

In certain instances, the system may include a stripping column. The stripping column may be in fluid communication with and between the separator and the gas flare. The stripping column may receive water from the separator at an inlet. The stripping column may use steam and chemicals to treat the water. The stripping column may discharge evaporates to the gas flare.

Aspects of the present disclosure include a method for producing oil from feedstock containing hydrocarbons. The method may include: receiving a vapor that contains hydrocarbons and receiving a first portion of light oil into a first condenser; cooling the vapor with the first portion of light oil and condensing a first portion of the vapor into a first portion of heavy oil in the first condenser; discharging a second portion of the vapor and the first portion of heavy oil from the first condenser; receiving the second portion of the vapor and a second portion of light oil into a second condenser; cooling the second portion of vapor with the second portion of light oil and condensing a third portion of the vapor into a second portion of heavy oil in the second condenser; discharging a non-condensable portion of the vapor, the second portion of heavy oil, and a mixture of light oil and water from the second condenser; separating the mixture of light oil and water into light oil and water and discharging the light oil from a separator; and supplying the first portion of light oil to the first condenser and the second portion of light oil to the second condenser.

In certain instances, the method may include receiving a circulating fluid in the first condenser, wherein the vapor rejects heat and the circulating fluid absorbs heat in the first condenser.

In certain instances, the method may include cooling the vapor to a temperature between approximately 250-degrees Fahrenheit and 300-degrees Fahrenheit within the first condenser.

In certain instances, the method may include collecting a mixture of light oil and water on a tray within the second condenser.

In certain instances, the method may include cooling the second portion of the vapor to a temperature between approximately 200-degrees Fahrenheit and 249-degrees Fahrenheit within the second condenser.

In certain instances, the method may include receiving the feedstock in a hopper, which may include a lid that removably seals hopper with respect to ambient air; supplying a purge gas, which may include the non-condensable portion of the vapor, to the hopper; supplying the feedstock to a retort; heating the feedstock until a first portion of the feedstock vaporizes into a vapor and a second portion of the feedstock is a solid mass; and removing particles from the vapor.

In certain instances, the hopper may receive the non-condensable portion of the vapor from the second condenser.

### BRIEF DESCRIPTION OF THE DRAWINGS

FIG. 1 illustrates a process diagram for heating feedstock to vaporize hydrocarbons and condensing the vapor into oil, in accordance with embodiments of the disclosure.

FIG. 2 illustrates another process diagram for heating feedstock to vaporize hydrocarbons and condensing the vapor into oil, in accordance with embodiments of the disclosure.

FIG. 3 illustrates a process diagram for heating feedstock to vaporize hydrocarbons and condensing the vapor into oil, in accordance with embodiments of the disclosure.

FIG. 4 illustrates a perspective view of a system for heating feedstock to vaporize hydrocarbons and condensing the vapor into oil, in accordance with embodiments of the disclosure.

FIGS. 5A-5B illustrate the results of laboratory testing performed on oil produced by an example system using tires as feedstock.

FIGS. 6A-6B illustrate the results of laboratory testing performed on both coal feedstock before processing and the char produced after processing the coal feedstock within an example system, respectively.

FIG. 7 illustrates the results of laboratory testing performed on syngas that was produced by an example system.

### DETAILED DESCRIPTION

The present disclosure relates to a system for processing feedstock that contains hydrocarbons. The system heats feedstock, which causes hydrocarbons within the feedstock to vaporize and the remaining feedstock, which does not vaporize, to become a solid char. The system cools the solid char and collects it. Separately, the system cools the hydrocarbon vapor, which causes the hydrocarbon vapor to condense into a heavy oil and a light oil. The heavy oil and light oil may be collected. The light oil may be recirculated through the system and used to cool the hydrocarbon vapor. Thus, the system processes feedstock and produces useful products, which may include char, heavy oil, and/or light oil. The components of the individually described systems may be applied to the other systems without limitation.

Several definitions that apply throughout this disclosure will now be presented:

The term “conduit” is defined as a tube, pipe, or channel to convey, or otherwise flow fluid. The conduit may be a system conduit or may connect two elements within the system, thereby establishing fluid communication between the two elements.

The term “heavy oil” is defined as oil with an American Petroleum Institute gravity (API gravity) less than 18-20. For example, asphalt and tar are heavy oils.

The term “light oil” is defined as oil with an API gravity exceeding 20. For example, Benzene, Toluene and Xylene (BTX) oil is a light oil.

The term “non-condensable vapor” is defined as vapor that does not condense at temperatures above 0-degrees Fahrenheit. In other words, the vapors do not condense until below 0-degrees Fahrenheit

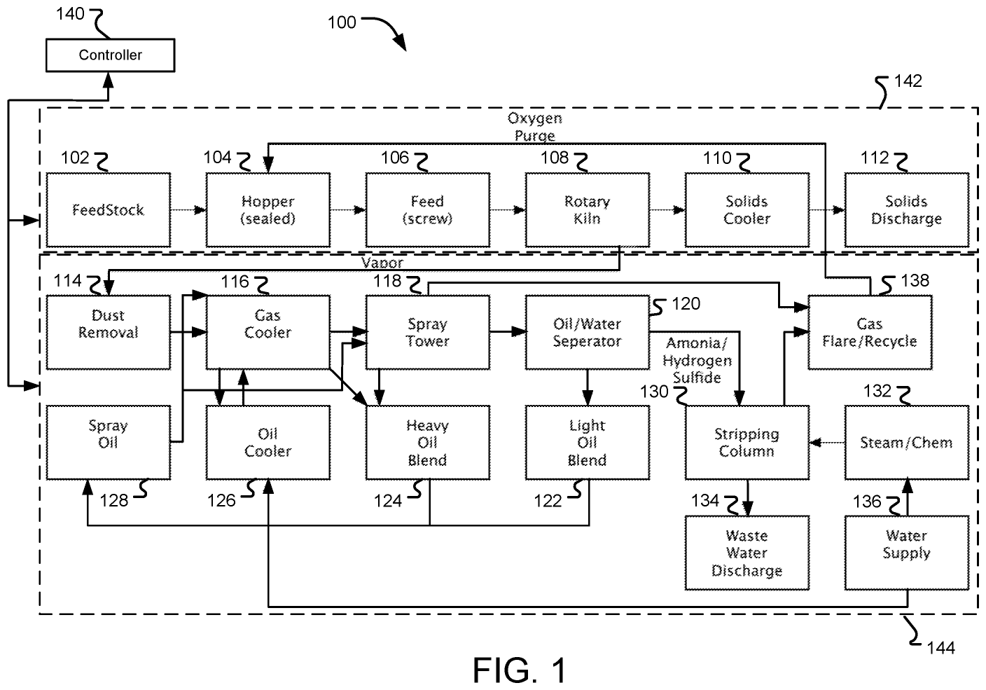

FIG. 1 illustrates one instance of an oil production system 100. The system 100 include a solids processing subsystem 142 and a vapor processing subsystem 144. The solids processing subsystem 142 heats the feedstock 102 to a sufficient temperature to vaporize hydrocarbons. Then, the vapor processing subsystem 144 condenses the vaporized hydrocarbons from a hot vapor state into a liquid oil state. Additionally, the system 100 may recover (1) the feedstock material post processing in a char form for refinement or other use and (2) the liquid oil for refinement or other use. The system 100 may also strip and recover non-carbon components from the feedstock material for refinement or other use. The system 100 may include one or more variable frequency drives (VFD) for various components within the system 100. Each VFD may control the speed of the motor for that component of the system 100, and may allow the motor speed to be adjusted, so that the system 100 may process various types of feedstock 102.

Beginning with the solids processing subsystem 142, the feedstock 102 is the material for the system 100 to process (i.e., the input material). The feedstock 102 may include any carbon-based material with sufficient hydrocarbon or volatile organic compound (VOC) characteristics. For example, the feedstock 102 may include coal, biomass-based material, rubber, plastics, and/or nutshells. As non-limiting examples, coal feedstock may include ground, fines, or tailings. Biomass-based material feedstock may include wood chips, wood pellets, and algae. Rubber feedstock may include tires. In one instance, when processed by the system 100, the biomass-based material may produce bio-oil.

The size of the feedstock 102 may affect heating rates and/or and vaporization rates of the feedstock 102. For example, smaller sized feedstock 102 may heat up and/or vaporize quicker than larger sized feedstock 102. In one instance, the feedstock 102 is ½″ minus (or approximately 12 mm minus). However, in other instances, the feedstock 102 may be ¼″ minus, ¾″ minus, 1″ minus, 1¼″ minus, 1½″ minus, 1¾″ minus, 2″ minus, 2¼″ minus, or 2½″ minus.

Before loading the feedstock 102 into the hopper 104, an operator may perform testing to determine one or more characteristics of the feedstock 102. For example, the operator may test the feedstock 102 to determine its moisture content and/or volatile content (e.g., type or types of volatiles, percentage or percentages of volatiles, etc.). In one instance, the moisture content of the feedstock 102 may be less than 10% before the feedstock 102 is fed into the hopper 104. The moisture content of the feedstock 102 may affect the energy input to process the feedstock 102. For example, feedstock 102 with a lower moisture content may require less energy input to process than feedstock 102 with a higher moisture content.

In one instance, a dryer (not shown in FIG. 1) may be used before the feedstock 102 is loaded into the hopper 104. The dryer may be configured to reduce the moisture content of the feedstock 102. Such reduction of the moisture content of the feedstock 102 may allow for faster vaporization of the hydrocarbons within the feedstock 102 when the feedstock 102 is heated within the rotary retort 108. Faster vaporization of the hydrocarbons may increase the efficiency of the rotary retort 108, which may allow for faster feed rates of the feedstock into the system 100 and faster processing rates of the feedstock 102 by the system 100.

A hopper 104 may receive the feedstock 102 at an inlet to the hopper 104 and discharge the feedstock 102 at the outlet of the hopper 104. The hopper 104 may have a top inlet, a body that tapers downwards and inwards (e.g., an inverted pyramidal or inverted conical shape), and a bottom outlet. The inlet may be configured to receive a large volume of feedstock 102. In one instance, the hopper 104 may be configured to receive approximately 10 tons of feedstock 102 and store the feedstock 102 until it is discharged at the hopper 104 outlet. The hopper 104 outlet may be adjustable, whereby the discharge rate of the feedstock 102 from the outlet may be controlled.

The feedstock 102 may be loaded into the hopper 104 in batches so that the hopper 104 inlet may then be sealed (i.e., after loading the feedstock 102) to prevent outside oxygen from becoming entrained in the feedstock 102. The size of the batches of feedstock 102 may vary. The batch size may be quantified by the time that the system 100 will take to process the feedstock 102 or by the weight of the feedstock 102. For example, approximately ½-hour of feedstock 102, approximately 1-hour of feedstock 102, or approximately 10 tons of feedstock 102 may be loaded into the hopper 104 at a time (i.e., in one batch). During operation of the system 100, the hopper 104 outlet may continuously discharge the feedstock 102.

The system 100 may process multiple batches of feedstock 102 continuously. In other words, the hopper 104 can be refilled with additional feedstock 102, while the system 100 is processing feedstock 102, when the amount of feedstock 102 within the hopper 104 starts to become low, even though the hopper 104 is loaded in batches. As described above, batch loading of the feedstock 102 and sealing of the hopper 104 in between loading the hopper 104 may prevent excess oxygen from becoming entrained in the feedstock 102, and, depending on the implementation, may allow for evacuation of oxygen.

The hopper 104 may include a lid, which seals the hopper 104 inlet (i.e., the inlet to load the feedstock 102) with respect to ambient air after the feedstock 102 is loaded into the hopper 104. In other words, the lid may be opened to load feedstock 102 into the hopper 104. Then, after the feedstock 102 is loaded into the hopper 104, the lid may be closed. In one instance, the lid may be hydraulically actuated to open and close the lid. Additionally, the hopper 104 outlet may include a rotary valve that substantially prevents excess oxygen from entering the rotary retort 108.

Use of the lid to seal the inlet of the hopper 104 and/or use of a rotary valve at the hopper 104 outlet may prevent or otherwise limit outside oxygen ingress into the hopper 104, excess oxygen from becoming entrained in the feedstock 102, and excess oxygen from entering the rotary retort 108. Excess oxygen entering the rotary retort 108 may cause combustion of the feedstock 102 when the feedstock 102 is heated inside the rotary retort 108. In some embodiments, the hopper 104 is a live bottom hopper. For example, the hopper 104 outlet can be a live bottom hopper that supplies feedstock 102 to the feed screw 106 such that the feedstock 102 (e.g., feedstock 102 within the hopper 104) provides an oxygen plug that reduces, if not eliminates, oxygen from entering the rotary retort 108 with the feedstock 102.

The hopper 104 may receive a purge gas, which may purge oxygen (e.g., oxygen purge) from the hopper 104. The purge gas may be heavier than oxygen so that it will disperse and/or remove (e.g., purge) oxygen from the hopper 104. For example, the purge gas may settle in the bottom of the hopper 104 and force oxygen upward and out of the hopper 104, thereby displacing and removing oxygen from the hopper 104. The purge gas may be, for example, an inert gas. As discussed below, the purge gas that to the hopper 104 may include non-condensable vapor that is recycled from the system 100 and/or gas from an independent purge-gas tank.

In one instance, the purge gas may include non-condensable vapor that is recycled (recirculated) from the system 100. For example, non-condensable vapor emitted from the system 100, prior to a flare (e.g., gas flare/recycle 138), can be routed to the hopper 104 and used as a purge gas. As discussed in the subsequent paragraphs, the non-condensable vapor may include vapor byproducts that may be produced within the system 100, included in the exhaust gas from the rotary retort 108 (e.g., a gas-fired rotary retort 108), included in the exhaust gas from the gas flare/recycle 138 (e.g., from burning/flaring non-condensable vapor and/or evaporates), or a combination thereof. These vapor byproducts may include carbon dioxide and/or carbon monoxide, which are heavier than oxygen.

For example (not shown in FIG. 1), the hopper 104 may receive vapor byproducts from the system 100 (e.g., from the spray tower 118). In other words, an outlet of the spray tower 118 may be connected by a conduit (purge line) to an inlet of the hopper 104, thereby establishing fluid communication between the spray tower 118 and the hopper 104.

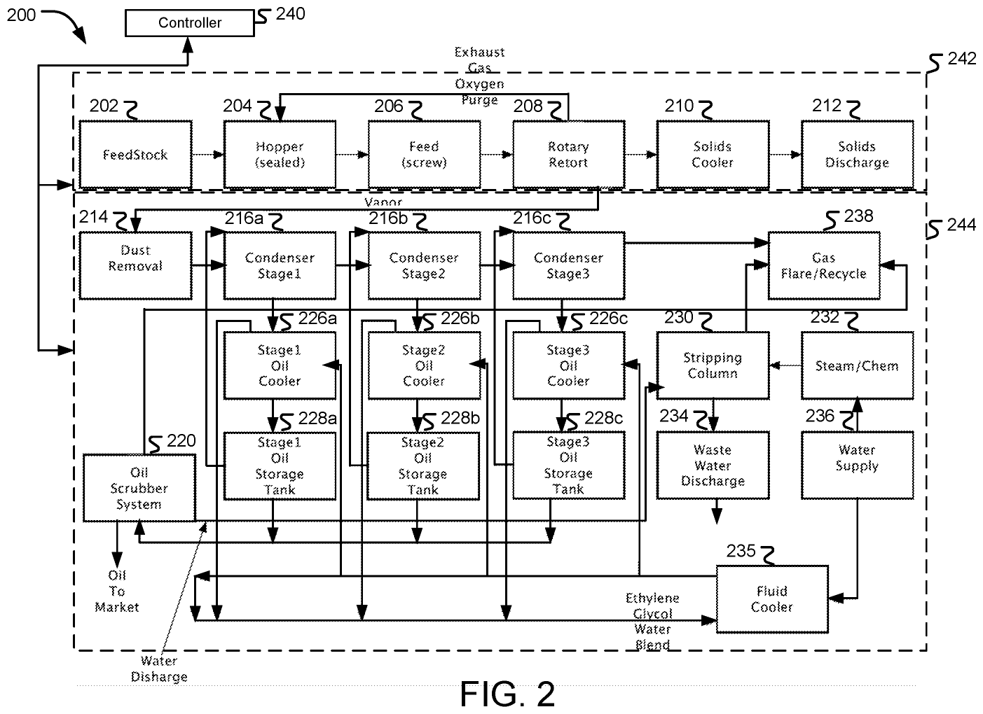

For example, as illustrated in FIG. 2, the hopper 104 may receive vapor byproducts from the exhaust gas of the rotary retort 108. In other words, an exhaust outlet of the rotary retort 108 may be connected by a conduit (purge line) to an inlet of the hopper 104, thereby establishing fluid communication between the rotary retort 108 and the hopper 104. For example, exhaust flue gas can be routed (e.g., rerouted) to the inlet of the rotary retort 108 and used as a purge gas to remove oxygen before the feedstock 102 enters the rotary retort 108. In some examples, the exhaust flue gas can be routed from the rotary retort 108 to the hopper 104 and used as a purge gas.

For example, as illustrated in FIG. 1, the hopper 104 may receive vapor byproducts from the exhaust gas of the gas flare/recycle 138. In other words, an exhaust outlet of the gas flare/recycle 138 is connected by a conduit (purge line) to an inlet of the hopper 104, thereby establishing fluid communication between the gas flare/recycle 138 and the hopper 104.

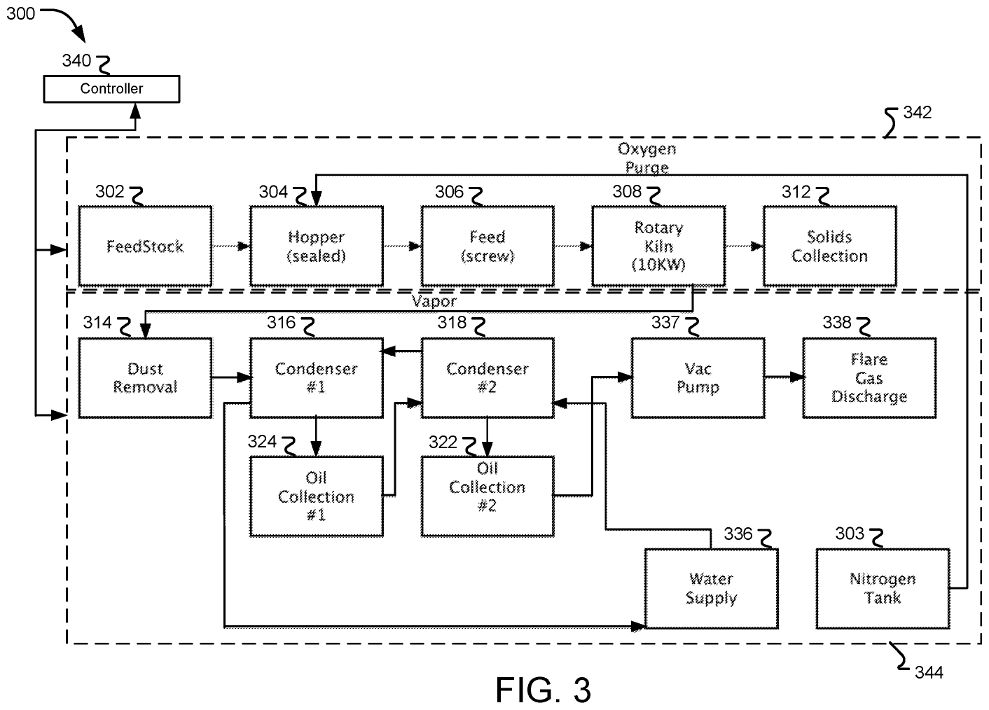

In another instance, as illustrated in FIG. 3, the hopper 304 may receive purge gas from an independent purge-gas tank 303. In other words, the independent purge-gas tank may store a purge gas, such as nitrogen or carbon dioxide. An outlet of the independent purge-gas tank may be connected by a conduit (purge line) to an inlet of the hopper 104, thereby establishing fluid communication between the independent purge-gas tank and the hopper 104.

A feed screw 106 (which can include one or more feed screws 106) may receive feedstock 102 from the hopper 104 and convey the feedstock 102 to the rotary retort 108. The feed screw 106 may be sealed (e.g., a sealed port) to prevent or otherwise limit outside oxygen ingress into the feed screw 106, excess oxygen from becoming entrained in the feedstock 102, and excess oxygen from entering the rotary retort 108.

In one instance, the feed screw 106 may include a tube with an internal auger (e.g., a screw) that rotates. A receiving end (e.g., a first end) of the feed screw 106 receives feedstock 102 from the hopper, the auger rotates to convey the feedstock 102, and a discharging end (e.g., a second end) of the feed screw 106 supplies the feedstock 102 to the rotary retort 108. The feed screw 106 may be oriented horizontally or the feed screw 106 may be inclined for gravity assisted movement of the feedstock to the kiln. In some embodiments, the feed screw 106 includes a chute around the feed auger mounted to a rotating tube. This can reduce, if not eliminate, the potential of the material feed housing becoming plugged with material if the level inside the tube rises above the opening inside the tube and causing material to fill in the area between the rotating tube and the stationary housing.

The feed screw 106 may include a variable frequency drive (VFD) that can adjust the feed rate of the feed screw 106. In other words, the VFD may control the rate at which the feed screw 106 supplies feedstock 102 to the rotary retort 108. For example, the VFD may be adjusted to accommodate different feed rates necessitated by the material characteristics (e.g., moisture content and/or volatile content) of the feedstock 102. In one instance, the feed screw 106 feed rate and the hopper 104 feed rate may be simultaneously adjusted.

A rotary retort 108 (e.g., a rotary kiln) is configured to heat the feedstock 102 to a sufficient temperature to vaporize hydrocarbons (which may include VOCs) within the feedstock 102. In other words, the rotary retort 108 heats the feedstock 102 to produce a hydrocarbon vapor and remaining solid material. The rotary retort 108 can heat the feedstock 102 for a period of time (e.g., residence time) and/or until the feedstock 102 reaches a temperature (e.g., threshold temperature). In some aspects, the temperature and/or period of time can be predetermined. In other words, the rotary retort 108 can heat the feedstock material 102 to a predetermined temperature and/or for a predetermined period of time. The solid material that remains after heating the feedstock 102 may be char that has been stripped of hydrocarbons (vaporized out). In other words, the rotary retort 108 receives feedstock 102 and discharges both a hydrocarbon vapor and a solid material (e.g., char). This application incorporates by reference, in its entirety, U.S. patent application Ser. No. 12/854,826, filed Aug. 11, 2010, and titled “Retort,” which issued as U.S. Pat. No. 8,328,992 on Dec. 11, 2012. This application incorporates by reference, in its entirety, U.S. patent application Ser. No. 16/457,437, filed Jun. 28, 2019, titled “Horizontal Rotating Drum Retort,” which issued as U.S. Pat. No. 11,168,258 on Nov. 9, 2021.

In one instance, the rotary retort 108 may receive the feedstock 102 from the feed screw 106. In other words, the discharge end of the feed screw 106 is in communication with the inlet of the rotary retort 108. A seal (e.g., sealed port), which allows free rotation of the rotary retort 108 while preventing oxygen from entering the rotary retort 108, may be included at the inlet of the rotary retort 108. Each seal can be replaceable (e.g., not integrated into the rotary retort 108). In some embodiments, the seal is a bellow seal. In other embodiments, the seal is a duplex high temperature seal. For example, the duplex high temperature seal can include silicone impregnated fabric wrapped on both sides by a high temperature vermiculite impregnated fabric. In this manner, the seal can withstand a higher temperature while reducing the risk of causing damage to the seal at those higher temperatures. In some embodiments, the inlet and/or vapor outlet of the rotary retort 108 includes a digital vacuum gage. Each digital vacuum gauge can monitor the vacuum (e.g., pressure), which can allow the operator to monitor and/or troubleshoot potential plugging of equipment (e.g., rotary retort 108) and/or conduit (e.g., piping). In some embodiments, the rotary retort 108 include a flue gas inlet, which can include piping and an isolation valve. The flue gas inlet, if present, can allow the rotary retort 108 to pull any sweep gas needed by pulling low oxygen gas from the natural gas burners exhaust stack with an inline valve to reduce flow if needed.

The rotary retort 108 may include multiple heating zones and a cooling zone. In one instance, the rotary retort 108 has two heating zones and one cooling zone. In another instance, the rotary retort 108 has three heating zones and one cooling zone. The feedstock 102 is continuously passed through each heating zone. The temperature in each individual heating zone may be controlled independently of each of the other heating zones. Thus, the temperature in each heating zone may be adjusted based on system 100 variables (e.g., feed rate of the feedstock 102) and characteristics of the feedstock 102 (e.g., moisture content and/or volatile content). Each heating zone may be self-modulating to maintain each heating zone at a pre-determined and pre-selected temperature.

For example, the rotary retort 108 may process coal at an operating temperature between 1000-degrees Fahrenheit and 1200-degrees Fahrenheit, which may depend on characteristics of the coal (including the moisture content). The coal may be heated to a temperature between 800-degrees Fahrenheit and 1000-degrees Fahrenheit, which may depend on characteristics of the coal (including the volatile content).

The rotary retort 108 may include a variable frequency drive (VFD) that can adjust the rate of rotation of the rotary retort 108. In other words, the VFD may control the rate at which the rotary retort 108 rotates. For example, the VFD may be adjusted to accommodate different feed rates necessitated by the material characteristics (e.g., moisture content and/or volatile content) of the feedstock 102. In some embodiments, the rotary retort 108 includes one or more isolation slide gates that correspond to the one or more burners of the rotary retort 108. In case of a burner failure, the isolation slide gate can reduce, if not eliminate, the risk of hot air backflowing into the non-operational burner. In turn, this can provide safety by reducing the risk of burning out burner controls and causing damage to wiring and other burner components.

The rotary retort 108 may be configured to operate with various energy sources to generate heat. The energy source may be selected based on the geographical location of the system 100 and/or available resources. For example, the rotary retort 108 may operate with the following heat sources: natural gas, propane, oil, electric (e.g., resistive or induction), plasma, or solid fuel (e.g., coal, wood). In some aspects, the rotary retort 108 can receive non-condensable vapor, which can include natural gas (e.g., propane, methane, ethane), that is produced within the system 100. For example, if the rotary retort 108 is natural gas fired, non-condensable vapor (e.g., produced by the rotary retort 108) can be supplied to the rotary retort 108 to burn as fuel.

In one instance, the rotary retort 108 is a rotary tube shell, set on a frame and mounted at a slight decline. The decline of the shell controls, in part, the residence time of the feedstock 102 inside the rotary retort 108. The tube may be constructed of 253 MA stainless steel to reduce the risk of the tube sagging and/or warping due to the high operating heat. In some aspects, the rotation speed of the rotary tube shell is controlled by a VFD, such that the rotation speed of the shell can be adjusted (e.g., increased, decreased). In some aspects, adjusting the speed can be correlated to (e.g., control) the speed in which the feedstock 102 moves through the rotary retort 108 (e.g., from the inlet to the feedstock discharge). For example, increasing the rotation speed of the rotary tube shell can increase the speed that the feedstock 102 moves through the rotary retort 108. Decreasing the rotation speed of the rotary tube shell can decrease the speed that the feedstock 102 in the rotary retort 108. In some aspects, adjusting the speed can be inversely correlated to (e.g., control) the residence time of the feedstock 102 in the rotary retort 108. For example, increasing the rotation speed of the rotary tube shell can decrease the residence time of the feedstock 102 in the rotary retort 108. Decreasing the rotation speed of the rotary tube shell can increase the residence time of the feedstock 102 in the rotary retort 108.

The rotary retort 108 may discharge hydrocarbon vapor at a vapor outlet and may discharge solid material (e.g., char) at a solids outlet. A seal (e.g., sealed port), which allows free rotation of the rotary retort 108 while preventing oxygen from entering the rotary retort 108, may be included at the vapor outlet and/or the solids outlet. Each seal can be replaceable (e.g., not integrated into the rotary retort 108). In some embodiments, the seal is a bellow seal. In other embodiments, the seal is a duplex high temperature seal. For example, the duplex high temperature seal can include silicone impregnated fabric wrapped on both sides by a high temperature vermiculite impregnated fabric. In this manner, the seal can withstand a higher temperature while reducing the risk of causing damage to the seal at those higher temperatures.

A vacuum (not shown in FIG. 1) may be configured to pull the hydrocarbon vapor through the vapor outlet of the rotary retort 108 and into the vapor condensing system, as discussed below. For example, the vacuum (also referred to as the vacuum fan) can pull the hydrocarbon vapor through the vapor outlet of the rotary retort 108 and through the components of the system 100 that further process the hydrocarbon vapor (e.g., dust remover 114, gas cooler 116, spray tower 118. For example, the vacuum may be a light vacuum operating at a pressure less than ½-inch of water column. In some embodiments, the inlet and/or outlet of the vacuum fan includes a digital vacuum gage. Each digital vacuum gauge can monitor the vacuum (e.g., pressure), which can allow the operator to monitor and/or troubleshoot potential plugging of equipment (e.g., vacuum fan) and/or conduit (e.g., piping). In some embodiments, the vacuum fan includes a primary vacuum fan and a secondary (or backup) vacuum fan. For example, the vacuum fan can be a duplex vacuum fan with a diverter valve. Together, the primary and backup vacuum fan can reduce the risk of catastrophic failure of the system. For example, the primary and backup fan reduces the risk of the retort going positive and causing a fire.

Turning to the solid material discharge from the rotary retort 108, the solid material discharge can include a quench auger and/or a char chute. In some embodiments, the solids outlet of the rotary retort 108 includes a quench auger. The quench auger can provide a complete oxygen free seal for the solid material (e.g., char) exiting the rotary retort 108. This can reduce, if not eliminate, oxygen from entering the rotary retort 108. Moreover, the quench auger can provide cooling (e.g., initial cooling) of the solid material. Additionally or separately, in some embodiments, the solids outlet of the rotary retort 108 includes a char chute (also referred to as a char discharge chute) that discharges the solid material (e.g., char) from the rotary retort 108. In some examples, the char chute includes fire suppression injection that is configured to suppress a fire, if a fire occurs (e.g., a fire within the char chute). For example, the fire suppression injection within the char chute can include fast act controls, such that an operator can quench a fire before it spreads through the system (e.g., before fire spreads through the rotary retort 108 and/or downstream piping). In some examples, the fire suppression injection can deploy a high volume of non-combustible gases, or similar, in response to a fire.

A solids cooler 110 is configured to reduce the temperature of the solid material, which may be recovered for refinement or other use. As non-limiting examples, the solids cooler 110 may include a vibrating screen or it may include air blowing across a conveyor.

In one instance, the solids cooler 110 may receive the solid material (e.g., char) from the rotary retort 108. In other words, the solids outlet of the rotary retort 108 is in communication with the solids cooler 110. In another example, the solids cooler 110 may be incorporated into the rotary retort 108.

A solids discharge 112 is configured to store the solid material. In one instance, the solids discharge 112 stores the solid material in an open area after the solid material has been cooled (as discussed above). As non-limiting examples, the solids discharge 112 may be collected in a bin, simply stored in piles on the ground, placed in a dump truck or the like for transport or otherwise.

In one instance, the solids discharge 112 may receive the solid material (e.g., char) from the solids cooler 110. As previously noted, the solid material may be recovered for refinement or other use. In one instance, any non-carbon components may be stripped and recovered from the solid material for refinement or other use. For example, when rubber tires are the feedstock 102 processed by the system 100, steel may be stripped (from the rubber) and recovered for refinement or other use.

As discussed above, the system 100 processes the feedstock 102 to produce a solid material (e.g., char), which is a useful product, in the rotary retort 108. However, the system 100 also produces vapors in the rotary retort 108, which may be further processed to also produce useful products, as discussed below.

Turning more particularly now to the vapor processing subsystem 144, hydrocarbon vapor is discharged from the rotary retort 108, as discussed above, and received by the vapor processing subsystem 144. In some embodiments, the conduit (e.g., piping) of the vapor processing subsystem 144 does not include any 90-degree elbows. In at least one example, the conduit of the condensing system (e.g., gas cooler 116, spray tower 118, oil cooler 126) of the vapor processing subsystem 144 does not include any 90-degree elbows. Excluding (e.g., removing) 90-degree elbows can reduce the amount of material build up within the conduit. Moreover, excluding 90-degree elbows can decrease the load on the vacuum fan. In some embodiments, the conduit (e.g., piping) of the vapor processing subsystem 144 does not include any flat piping. In at least one example, the conduit of the condensing system (e.g., gas cooler 116, spray tower 118, oil cooler 126) of the vapor processing subsystem 144 does not include any flat piping. Excluding (e.g., removing) flat piping, or otherwise having all conduit angled towards or away from the condensing columns, can reduce the amount of material build up within the conduit.

The vapor outlet of the rotary retort 108 can include a discharge hood (also referred to as a vapor discharge hood) that discharges the hydrocarbon vapor from the rotary retort 108. In some embodiments, the discharge hood includes insulation and/or heat tape. For example, insulation and/or heat tape can be wrapped around the discharge hood of the rotary retort 108. When present, the insulation and/or heat tape (e.g., when energized or otherwise supplying heat) can reduce, if not eliminate, premature condensation (e.g., condensation occurring before the gas cooler 116) of the hydrocarbon vapor, such as condensation on an interior surface of the discharge hood. Such reduction, or elimination, of premature condensation correspondingly increases the efficiency in the system 100. In some embodiments, the discharge hood can include a temperature sensor (e.g., a thermocouple) that measures the temperature of the hydrocarbon vapor. In this manner, the temperature sensor can monitor the temperature of the hydrocarbon vapor. A temperature sensor, if present at the discharge hood, can provide the operator with a reading of the actual temperature of the vapor exiting the rotary retort 108.

A dust remover 114 (also referred to as a dust collector) can be positioned in line with the vapor discharge (e.g., discharge hood) of the rotary retort 108. The dust remover 114 removes dust particles from the hydrocarbon vapor, which may reduce or eliminate dust from entering the condensing portion of the system 100. The presence of dust may increase the risk of equipment failure and otherwise cause problems (e.g., agglomerating and plugging up the equipment downstream from the vapor discharge). As non-limiting examples, the dust remover 114 may include passing the vapor stream through a vortex baffle box, a contact separator, or a cyclone. This allows the particles to slow down and strike the baffles and drop out of the vapor flow stream. In some embodiments, the dust remover 114 includes a fire suppression injection that is configured to suppress a fire, if a fire occurs, within the dust remover 114. For example, the fire suppression injection within the dust remover 114 can include fast act controls, such that an operator can quench a fire before it spreads through the system 100. In some examples, the fire suppression injection can deploy a high volume of non-combustible gases, or similar, in response to a fire.

In one instance, the dust remover 114 may receive the hydrocarbon vapor from the rotary retort 108. In other words, the vapor outlet of the rotary retort 108 is connected by a conduit (also referred to as piping) to the inlet to the dust remover 114, thereby establishing fluid communication between the rotary retort 108 and the dust remover 114. The vacuum (as previously described) may be configured to supply the hydrocarbon vapor from the rotary retort 108 to the dust remover 114. In other words, the vacuum may pull the hydrocarbon vapor through the vapor outlet of the rotary retort 108 and through the components of the system 100 that further process the hydrocarbon vapor (e.g., dust remover 114, gas cooler 116, and spray tower 118). In some embodiments, the conduit between the rotary retort 108 and the dust remover 114 includes insulation and/or heat tape. For example, insulation and/or heat tape can be wrapped around the conduit. When present, the insulation and/or heat tape (e.g., when energized or otherwise supplying heat) can reduce, if not eliminate, premature condensation (e.g., condensation occurring before the gas cooler 116) of the hydrocarbon vapor, such as condensation on an interior surface of the conduit. Such reduction, or elimination, of premature condensation correspondingly increases the efficiency in the system 100.

In some embodiments, the dust remover 114 includes insulation and/or heat tape. For example, insulation and/or heat tape can be wrapped around the dust remover 114. When present, the insulation and/or heat tape (e.g., when energized or otherwise supplying heat) can reduce, if not eliminate, premature condensation (e.g., condensation occurring before the gas cooler 116) of the hydrocarbon vapor, such as condensation on an interior surface of the dust remover 114. Such reduction, or elimination, of premature condensation correspondingly increases the efficiency in the system 100. In some embodiments, the dust remover 114 includes an access door, which can provide access to the interior of the dust remover 114. In this manner, the access door of the dust remover 114 can allow for inspection and/or cleaning of the dust remover 114. In some embodiments, the inlet and/or outlet of the dust remover 114 includes a digital vacuum gage. Each digital vacuum gauge can monitor the vacuum (e.g., pressure), which can allow the operator to monitor and/or troubleshoot potential plugging of equipment (e.g., dust remover 114) and/or conduit (e.g., piping).

A first condenser (e.g., gas cooler 116) reduces the temperature of the hydrocarbon vapor. Such temperature reduction may condense a portion of the hydrocarbon vapor from a heated vapor state into a liquid oil state, which may include heavy oil. The gas cooler 116 may discharge heavy oil to the heavy oil blend tank 124 (as described below).

In one instance, the gas cooler 116 receives the hydrocarbon vapor from the dust remover 114. In other words, the outlet of the dust remover 114 is connected by a conduit to an inlet of the gas cooler 116, thereby establishing fluid communication between the dust remover 114 and the gas cooler 116. The vacuum (as previously described) may be configured to supply the hydrocarbon vapor from the dust remover 114 to the gas cooler 116. In other words, the vacuum may pull the hydrocarbon vapor through the vapor outlet of the rotary retort 108 and through the components of the system 100 that further process the hydrocarbon vapor (e.g., dust remover 114, gas cooler 116, and spray tower 118). In some embodiments, the conduit connecting the outlet of the dust remover 114 to the inlet of the gas cooler 116 includes a spray nozzle (also referred to as an oil spray nozzle). For example, the spray nozzle can be after (e.g., immediately exiting) the dust remover 114. The spray nozzle can assist in the condensing of the hydrocarbon vapor and/or can assist in cleaning any potential dust build up on the conduit (e.g., piping). In some embodiments, the conduit between the dust remover 114 and the gas cooler 116 includes insulation and/or heat tape. For example, insulation and/or heat tape can be wrapped around the conduit. When present, the insulation and/or heat tape (e.g., when energized or otherwise supplying heat) can reduce, if not eliminate, premature condensation (e.g., condensation occurring before the gas cooler 116) of the hydrocarbon vapor, such as condensation on an interior surface of the conduit. Such reduction, or elimination, of premature condensation correspondingly increases the efficiency in the system 100.

In one possible example, the gas cooler 116 may include two stages. In one instance, the temperature of the hydrocarbon vapor may be between approximately 600-degrees Fahrenheit and 800-degrees Fahrenheit when the gas cooler 116 receives the hydrocarbon vapor. The gas cooler 116 may reduce the temperature of the hydrocarbon vapor to between approximately 250-degrees Fahrenheit and 300-degrees Fahrenheit.

A first stage of the gas cooler 116 may include a heat exchanger, which may be, for example, a coil or shell with a circulating fluid (e.g., cooling fluid) circulating through it. As the hot hydrocarbon vapor passes over the coil in the gas cooler 116, the circulating fluid absorbs heat and the hydrocarbon vapor rejects heat. Thus, indirect heat transfer reduces the temperature of the hydrocarbon vapor and begins condensing a portion of the hydrocarbon vapor into a liquid state. In one instance, the gas cooler 116 may receive the circulating fluid from the oil cooler 126. In other words, an outlet of the oil cooler 126 is connected by a conduit to an inlet of the gas cooler 116, thereby establishing fluid communication between the oil cooler 126 and the gas cooler 116.

Turning more particularly now to the oil cooler 126, an oil cooler 126 may receive the circulating fluid from the gas cooler 116 (after the circulating fluid absorbs heat in the gas cooler 116). In other words, an outlet of the gas cooler 116 is connected by a conduit to the inlet of the oil cooler 126, thereby establishing fluid communication between the gas cooler 116 and the oil cooler 126.

The oil cooler 126 is configured to reduce the temperature of the circulating fluid prior to recirculating the circulating fluid to the gas cooler 116. Thus, within the oil cooler 126, the circulating fluid may reject heat and a cooling fluid may absorb heat. As previously discussed, the circulating fluid is recirculated to gas cooler 116 wherein the circulating fluid absorbs heat and the hydrocarbon vapor rejects heat.

In one instance, the oil cooler 126 may be a water over coil, closed loop cooling tower to reduce the temperature of the circulating fluid. The circulating fluid may be oil, such as a therminol-type oil, and the cooling fluid may be water. For example, the oil cooler 126 may receive water from a water supply 136. In other words, an outlet from the water supply 136 may be connected by a conduit to an inlet of the oil cooler 126, thereby establishing fluid communication between the water supply 136 and the oil cooler 126. Within the oil cooler 126, the circulating fluid (e.g., oil) rejects heat and the cooling fluid (e.g., water) absorbs heat, which may cause the water to evaporate. Thus, the temperature of the circulating fluid is reduced before the circulating fluid is recirculated to the gas cooler 116.

Returning to the gas cooler 116, the second stage of the gas cooler 116 may include spraying light oil, using one or more spray nozzles, directly into the vapor stream of the hydrocarbon vapor. The light oil may have a lower temperature than the hydrocarbon vapor in the vapor stream, thereby using direct contact to reduce the temperature of the hydrocarbon vapor. Such temperature reduction may begin condensing a portion of the hydrocarbon vapor into a liquid state. Moreover, spraying light oil may also provide a method of motion to keep any condensing liquids flowing in motion, which may prevent material (e.g., heavy oil, tar, etc.) from sticking to surfaces (such as heat transfer surfaces). For example, spraying light oil may dilute the heavy oils.

In one instance, the light oil that is supplied to the gas cooler 116 is recycled (recirculated) light oil from within the system 100 (e.g., produced by the system 100). For example, the gas cooler 116 may receive light oil from the spray oil tank 128. In other words, an outlet of the spray oil tank 128 is connected by a conduit to an inlet of the gas cooler 116, thereby establishing fluid communication between the spray oil tank 128 and the gas cooler 116. The spray oil tank 128 may receive light oil from the light oil blend tank 122 (as described below) and the light oil blend tank 122 may receive light oil from the oil/water separator 120 (as described below). Recycling light oil may reduce the potential for contamination within the system 100, because introducing outside oil (from outside the system 100) into the spray oil tank 128 (rather than using light oil produced within the system 100) may cause contamination.

The gas cooler 116 may discharge heavy oil (e.g., hydrocarbon vapor that condensed into heavy oil within the gas cooler 116) to the heavy oil blend tank 124 (as described below). The gas cooler 116 may discharge hydrocarbon vapor (e.g., hydrocarbon vapor that did not condense into heavy oil within the gas cooler 116) to the spray tower 118.

A second condenser (e.g., a spray tower 118) reduces the temperature of the hydrocarbon vapor. Such temperature reduction may condense a portion of the hydrocarbon vapor from a heated vapor state into a liquid oil state, which may include heavy oil and/or light oil. The spray tower 118 may discharge heavy oil to the heavy oil blend tank 124 (as described below) and may discharge light oil and/or water to the oil/water separator 120 (as described below).

In one instance, the spray tower 118 may receive the hydrocarbon vapor from the gas cooler 116. In other words, the outlet of the gas cooler 116 is connected by a conduit to the inlet of the spray tower 118, thereby establishing fluid communication between the gas cooler 116 and the spray tower 118. The vacuum (as previously described) may be configured to supply the hydrocarbon vapor from the gas cooler 116 to the spray tower 118. In other words, the vacuum may pull the hydrocarbon vapor through the vapor outlet of the rotary retort 108 and through the components of the system 100 that further process the hydrocarbon vapor (e.g., dust remover 114, gas cooler 116, and spray tower 118).

The spray tower 118 may be a 2-stage oil scrubber, which may reduce the temperate of the hydrocarbon vapor from its entering temperature to a temperature of approximately 200-degrees Fahrenheit to 249-degrees Fahrenheit. For example, light oil may be pumped into the top of the spray tower 118. The vapor stream (e.g., hydrocarbon vapor) enters the bottom of the spray tower 118 and flows up through a contact/bubble type tray (e.g., condensing tray). As the hydrocarbon vapor flows upward it comes into contact with the light oil, which may a lower temperature than the hydrocarbon vapor in the vapor stream. Thus, the light oil condenses a portion of the hydrocarbon vapor into a liquid form, which may include heavy oil and/or light oil. Heavy oil may flow into the bottom of the oil scrubber and light oil may be received by the condensing tray.

In one possible example, the light oil that is supplied to the spray tower 118 is recycled (recirculated) light oil from within the system 100 (e.g., produced by the system 100). For example, the spray tower 118 may receive light oil from the spray oil tank 128. In other words, an outlet of the spray oil tank 128 is connected by a conduit to an inlet of the spray tower 118, thereby establishing fluid communication between the spray oil tank 128 and the spray tower 118. The spray oil tank 128 may receive light oil from the light oil blend tank 122 (as described below) and the light oil blend tank 122 may receive light oil from the oil/water separator 120 (as described below). Recycling light oil may reduce the potential for contamination within the system 100, because introducing outside oil (from outside the system 100) into the spray oil tank 128 (rather than using light oil produced within the system 100) may cause contamination.

The spray tower 118 may discharge heavy oil (e.g., hydrocarbon vapor that condensed into heavy oil within the spray tower 118) to the heavy oil blend tank 124. The spray tower 118 may discharge light oil (e.g., captured by the condensing tray) to the oil/water separator 120 (as described below). The spray tower 118 may discharge non-condensable vapor to the gas flare/recycle 138 (as described below).

A heavy oil blend tank 124 (e.g., a storage tank for heavy oil blend) may receive and collect, or otherwise store, the heavy oil. The heavy oil blend tank 124 may be configured to prevent the excessive heavy oil buildup (e.g., gumming). In other words, the viscosity of the heavy oil may be maintained near a predetermined level within the heavy oil blend tank 124. For example, the heavy oil blend tank 124 may be heated and/or the heavy oils may be diluted within the heavy oil blend tank 124.

In one instance, the heavy oil blend tank 124 may receive heavy oil from the gas cooler 116 and/or spray tower 118 (e.g., heavy oil that condensed from the hydrocarbon vapor within the gas cooler 116 and/or spray tower 118). An outlet of the gas cooler 116 may be connected by a conduit to an inlet of the heavy oil blend tank 124, thereby establishing fluid communication between the gas cooler 116 and the heavy oil blend tank 124. An outlet of the spray tower 118 may be connected by a conduit to an inlet of the heavy oil blend tank 124, thereby establishing fluid communication between the spray tower 118 and the heavy oil blend tank 124.

An oil/water separator 120 may separate light oil from water. After the oil/water separator 120 separates light oil and water, the light oil may be a BTX-type oil. In one instance, the oil/water separator 120 receives light oil, which may include water, from the spray tower 118 (e.g., from the condensing tray within the spray tower 118). In other words, an outlet of the spray tower 118 is connected by a conduit to the inlet to the oil/water separator 120, thereby establishing fluid communication between the spray tower 118 and the oil/water separator 120. In one instance, the oil/water separator 120 may be incorporated into the spray tower 118.

The oil/water separator 120 may discharge the light oil into a light oil blend tank 122. The oil/water separator 120 may discharge water (which may include ammonia and/or hydrogen sulfide) into a stripping column 130 (as described below).

A light oil blend tank 122 (e.g., a storage tank for light oil blend) may receive and collect, or otherwise store, the light oil, which may be a BTX-type oil. In one instance, the light oil blend tank 122 may receive light oil (e.g., from the condensing tray within the spray tower 118) from the oil/water separator 120. In other words, an outlet of the oil/water separator 120 is connected by a conduit to the inlet of the light oil blend tank 122.

As previously described, the light oil may be recycled (recirculated) to be used as a cooling medium in the gas cooler 116 and/or spray tower 118. In other words, the light oil blend tank 122 may discharge light oil to the spray oil tank 128.

The spray oil tank 128 may receive and collect, or otherwise store, the light oil, which may be a BTX-type oil. In one instance, the spray oil tank 128 may receive light oil from the light oil blend tank 122. In other words, an outlet of the light oil blend tank 122 is connected by a conduit to the inlet of the spray oil tank 128. The spray oil tank 128 may provide a reservoir of light oil that can be supplied to the gas cooler 116 and/or spray tower 118 when the system 100 is started. In other words, on startup, the system 100 has light oil available in the spray oil tank 128, although the system is just beginning to process feedstock 102.

As previously described, the light oil may be recycled (recirculated) to be used as a cooling medium in the gas cooler 116 and/or spray tower 118. In other words, the spray oil tank 128 may discharge light oil to the gas cooler 116 and/or spray tower 118. Recycling light oil may reduce the potential for contamination within the system 100, because introducing outside oil (from outside the system 100) into the spray oil tank 128 (rather than using light oil produced within the system 100) may cause contamination.

A stripping column 130 may remove ammonia and/or hydrogen sulfide from the water. In one instance, the stripping column 130 may use steam, chemicals, or a combination thereof to strip (e.g., remove) ammonia and/or hydrogen sulfide from the water. In another instance, the system 100 does not include a stripping column 130. In one instance, the water may be trucked away from the location of the system 100. In another instance, a water treatment device may be added to the system 100 to further treat the water.

In one instance, the stripping column 130 may receive water, which may include ammonia and/or hydrogen sulfide, from the oil/water separator 120. In other words, the outlet of the oil/water separator 120 is connected by a conduit to an inlet of the stripping column 130, thereby establishing fluid communication between the oil/water separator 120 and the stripping column 130.

The stripping column 130 may discharge water, which may include wastewater, to the wastewater discharge 134 (as described below). The stripping column 130 may receive steam and/or chemicals from the steam/chem 132.

A steam/chem 132 may supply steam and/or chemicals to the stripping column 130. In other words, the outlet of the steam/chem 132 is connected by a conduit to an inlet of the stripping column 130, thereby establishing fluid communication between the steam/chem 132 and the stripping column 130. The steam/chem 132 may include a steam generator to generate steam and may inject chemicals into the stripping column 130 to treat the water (e.g., remove ammonia and hydrogen sulfide). In one instance, the steam/chem 132 may receive water from the water supply 136 and the steam generator may turn the water into steam. In other words, an outlet of the water supply 136 is connected by a conduit to the inlet of the steam/chem 132, thereby establishing fluid communication between the water supply 136 and the steam/chem 132.

A wastewater discharge 134 may receive wastewater from the stripping column 130. In other words, the outlet of the stripping column 130 is connected by a conduit to an inlet of the wastewater discharge 134, thereby establishing fluid communication between the stripping column 130 and the wastewater discharge 134. An operator may test the wastewater to determine one or more characteristics (e.g., water quality and volume).

Based on the characteristics of the water, the wastewater may be discarded and/or recycled. For example, the wastewater may be trucked away from the site and/or discharged to the ground. In one instance (not shown in FIG. 1), wastewater may be recycled (recirculated) back to the system 100 (e.g., fluid cooler on the evaporative water makeup side).

A water supply 136 may supply water to various components in the system 100. As nonlimiting examples, the water supply 136 may include a water storage tank that stores water, connection to a water source or body of water (such as a lake or stream), or connection to a municipal water supply. A pump (not shown in FIG. 1) may be configured to supply the water to various components in the system 100. As one example, the water supply 136 may supply water for steam generation in the steam/chem 132 (as previously discussed). As another example, the water supply 136 may supply water (e.g., makeup water) to the oil cooler 126 (as previously discussed).

A gas flare/recycle 138 may recycle and/or burn off (i.e., flare) one or more gases from within the system 100. The gas flare/recycle 138 may receive non-condensable vapor from the spray tower 118. In other words, an outlet of the spray tower 118 is connected by a conduit to an inlet of the gas flare/recycle 138, thereby establishing fluid communication between the spray tower 118 and the gas flare/recycle 138. The vacuum (as previously described) may be configured to supply the non-condensable vapor from the spray tower 118 to the gas flare/recycle 138.

The non-condensable vapor may include vapor byproducts, which may be produced within the system 100. For example, the vapor byproducts may include carbon dioxide and/or carbon monoxide. In one instance, the vapor byproducts may be recycled (reused) within the system 100. For example (as previously described), the vapor byproducts may be supplied to the inlet of the rotary retort 108 and used as a purge gas to remove oxygen prior to feedstock 102 entering the rotary retort 108. In some examples, the vapor byproducts may be supplied to the hopper 104 and used as a purge gas within the hopper 104. In another instance, the vapor byproducts may be burned off (i.e., flared) by the gas flare/recycle 138. The vapor byproducts from the exhaust gas of the gas flare/recycle 138 may be supplied to the hopper 104 and used as a purge gas within the hopper 104.

The non-condensable vapor may include natural gas. For example, the non-condensable vapor may include propane, methane, and/or ethane. In one instance, the non-condensable vapor may be burned off (i.e., flared) by the gas flare/recycle 138. In another instance (not shown in FIG. 1), the non-condensable vapor may be recycled (reused) within the system 100. For example (not shown in FIG. 1), if the rotary retort 108 is natural gas fired, the non-condensable vapor may be supplied to the rotary retort 108 and used as fuel by the rotary retort 108. The rotary retort 108 may use the non-condensable vapor as the primary fuel or as supplemental fuel (in conjunction with a separate gas source). An outlet of the gas flare/recycle 138 may be connected by a conduit to an inlet of the rotary retort 108, thereby establishing fluid communication between the gas flare/recycle 138 and the rotary retort 108. Recycling (or otherwise reusing) non-condensable vapor (e.g., natural gas) as fuel for the rotary retort 108 can greatly reduce, if not eliminate, the need to purchase natural gas (e.g., from a pipeline network, from the grid) to fuel the rotary retort 108.

The gas flare/recycle 138 may receive evaporates (vapor) from the stripping column 130 (if a stripping column 130 is included in the system, as previously described). In other words, an outlet of the stripping column 130 is connected by a conduit to an inlet of the gas flare/recycle 138, thereby establishing fluid communication between the stripping column 130 and the gas flare/recycle 138. The vacuum (as previously described) may be configured to supply the evaporates from the stripping column 130 to the gas flare/recycle 138.

In one instance, the evaporates may be burned off (i.e., flared) by the gas flare/recycle 138. In another instance (not shown in FIG. 1), the evaporates may be recycled (reused) within the system 100. For example, if the rotary retort 108 is natural gas fired, the evaporates (along with the non-condensable vapor, as previously described) may be supplied to the rotary retort 108.

In other instances, the non-condensable vapor and/or evaporates may be supplied to a generator (not shown in FIG. 1). The generator may use the gas stream to generate power.

A scrubber (not shown in FIG. 1) may be added to the system 100. In one instance, if the non-condensable vapor and/or evaporates are supplied to a natural-gas fired rotary retort 108 for fuel, a scrubber may be added upstream (before) the inlet of the rotary retort 108. In another instance, if a non-condensable vapor and/or evaporates are supplied to a generator (not shown in FIG. 1) for the generator to use as fuel, a scrubber may be added upstream (before) the inlet to the generator. The scrubber may remove or otherwise reduce contaminates (such as particulates, trace liquid, and/or gases) from the gas stream, because contaminates may damage the rotary retort 108 and/or generator.

The system 100 can include a controller 140, which can provide signals to control various components of the system 100. The controller 140 can provide signals to control one or more of the components in the solids processing subsystem 142 (e.g., feedstock 102, hopper 104, feed screw 106, rotary retort 108, solids cooler 110, solids discharge 112) and/or one or more of the components in the vapor processing subsystem 144 (e.g., dust remover 114, gas cooler 116, spray tower 118, oil/water separator 120, light oil blend tank 122, heavy oil blend tank 124, oil cooler 126, spray oil tank 128, stripping column 130, steam/chem 132, wastewater discharge 134, water supply 136, gas flare/recycle 138). In one instance, the controller 140 can be provide signals to one or more variable frequency drives (VFDs) within the system 100. For example, the controller 140 can be communicatively coupled to a VFD for the feed screw 106, and the controller 140 may have instructions to control the feed rate of the feed screw 106. The controller 140 can be communicatively coupled to a VFD for the rotary retort 108, and the controller 140 may have instructions to control the rotation of the rotary retort 108. In another instance, the controller 140 can include feedback loops to control one or more valves within the system 100.

In some embodiments, the controller 140 includes a main programmable logic controller (also referred to as a PLC). In some examples, the PLC is fully integrated with the system 100 (e.g., solids processing subsystem 142, vapor processing subsystem 144) and includes a remote control. A PLC that is fully integrated with the system 100 and has a remote control can simplify the controls of the system 100 such as by having all data feed to a single point and having a wireless table that the operator can use to walk through the system 100 and make operational changes without having to return to the main control room PLC.

FIG. 2 illustrates one instance of an oil production system 200. The system 200 includes many of the same features as the system 100 in FIG. 1. Due to the similar features, the reference numbers and the description for the system 100 in FIG. 1 are also applicable to the system 200 in FIG. 2; however, the reference numbers in FIG. 2 are 200 series rather than 100 series. As described below, the system 200 in FIG. 2 can include one or more features that can be different than the features previously described for the system 100 in FIG. 1.

Similar to the system described in FIG. 1, the system 200 illustrated in FIG. 2 include a solids processing subsystem 242 and a vapor processing subsystem 244. The solids processing subsystem 242 heats the feedstock 202 to a sufficient temperature to vaporize hydrocarbons. Then, the vapor processing subsystem 244 condenses the vaporized hydrocarbons from a hot vapor state into a liquid oil state. The solids processing subsystem 242 (as illustrated for example in FIG. 2) can include one or more same or similar components as the solids processing subsystem 142 (as illustrated for example in FIG. 1). Similarly, the vapor processing subsystem 244 (as illustrated for example in FIG. 2) can include one or more same or similar components as the vapor processing subsystem 144 (as illustrated for example in FIG. 1).

In the solids processing subsystem 242, the hopper 204 can receive vapor byproducts from the exhaust gas (e.g., flue gas) of the rotary retort 208, as previously discussed. In other words, an exhaust outlet of the rotary retort 208 can be connected by a conduit (purge line) to an inlet of the hopper 204, thereby establishing fluid communication between the rotary retort 208 and the hopper 204. For example, exhaust flue gas can be routed to the inlet of the rotary retort 208 and used as a purge gas to remove oxygen prior to feedstock 202 entering the rotary retort 208. In some examples, the exhaust flue gas can be routed from the rotary retort 208 to the hopper 204 and used as a purge gas.

Continuing with FIG. 2, and turning to the vapor processing subsystem 244, the vapor processing subsystem 244 can include one or more condensing stages, which can be arranged in series. Each condensing stage can include a condenser 216 (e.g., 216a, 216b, 216c), an oil cooler 226 (e.g., 226a, 226b, 226c), and an oil tank 228 (e.g., 228a, 228b, 228c). In some embodiments, each condensing stage includes one or more gear pumps. In some embodiments, the gear pumps are internal gear pumps. In other embodiments, the gear pumps are external gear pumps, which can provide a greater resistance to back pressure. In some embodiments, each condensing stage includes on or more oil discharge pumps. In some embodiments, the oil discharge pumps are large pumps that include a variable frequency drive (VFD) that can control, for example, the speed of the pump. The VFD can modulate (e.g., adjust) the speed depending on various (e.g., changing) operating conditions. In turn, the VFD's with the oil discharge pumps will provide greater flow control in addition to creating greater versatility and capacity of the system.

Within each condensing stage, in some embodiments (as illustrated in FIG. 2), the condensed vapor (e.g., oil) flows from the condenser 216 (e.g., 216a, 216b, 216c), to the respective oil cooler 226 (e.g., 226a, 226b, 226c), to the respective oil tank 228 (e.g., 228a, 228b, 228c), and then at least a portion of the condensed vapor can be supplied back (e.g., sprayed) into the respective condenser 216. In other embodiments (not illustrated in FIG. 2), the condensed vapor flows from the condenser 216 (e.g., 216a, 216b, 216c), to the respective oil tank 228 (e.g., 228a, 228b, 228c), to the respective oil cooler 226 (e.g., 226a, 226b, 226c), and then at least a portion of the condensed vapor is supplied back (e.g., sprayed) into the respective condenser 216. In other words, the condensed vapor can be supplied from the condenser 216 to the oil tank 228, and then pumped out of the oil tank 228 (at an elevated temperature) and through the respective oil cooler 226 before being sprayed back into the condenser 216. This can reduce the amount of buildup in the oil cooler 226 and keep the condensed vapor (e.g., oil) in the oil tanks 228 at a higher temperature so that it is easier to pump.

Although the vapor processing subsystem 244 illustrated in FIG. 2 includes three condensing stages, the vapor processing subsystem 244 can include less than three condensing stages in some examples. In other examples, the vapor processing subsystem 244 can include more than three condensing stages. In some aspects, the number of condensing stages can vary according to the volume of product hydrocarbon vapors. In some aspects, the number of condensing stages can vary according to the temperature and/or residence time required for the condensing stages to condense the hydrocarbon vapors (e.g., completely condense the vapors from a vapor state to a liquid state).

Each condenser 216 (e.g., 216a, 216b, 216c) (also referred to as a condensing column, condensing vessel, or condenser vessel) reduces the temperature of hydrocarbon vapor using direct contact cooling (e.g., applying spray oil), which causes at least a portion of the hydrocarbon vapor to condense. Each condenser 216 receives both hydrocarbon vapor and oil. As the hydrocarbon vapor enters the condenser 216, the hydrocarbon vapors come into direct contact with oil sprays (e.g., the oil entering the condenser 216 is sprayed). For example, the condenser 216 can include a high-pressure spray pump and one or more internal spray nozzles configured to spray the oil directly into the vapor stream. In some embodiments, the spray pump for each condensing vessel is a vertical multistage pump. In other embodiments, the spray pump is an external gear pump, which can allow for more robust operation while pumping oil.

The temperature of the spray oil is lower than the temperature of the hydrocarbon vapor and, as a result, when the oil (lower temperature) directly contacts the hydrocarbon vapor (higher temperature), the temperature of the hydrocarbon vapor is reduced. In some examples, the temperature of the oil sprays can be approximately 120-degrees Fahrenheit. Thus, the oil sprays cool and condense the vaporized hydrocarbons into a liquid state (e.g., oil) when the oil contacts the hydrocarbon vapor. The condenser 216 includes a basin that collects condensed hydrocarbon vapor (e.g., oil). In other words, once the vapors have condensed, the condensed vapor (e.g., oil) pools in the basin of the condenser 216. In some embodiments (as illustrated in FIG. 2), the condensed vapor is discharged from the condenser 216 to the respective oil cooler 226 (e.g., 226a, 226b, 226c). In other embodiments (not illustrated in FIG. 2), the condensed vapor is discharged from the condenser 216 to the respective oil tank 228 (e.g., 228a, 228b, 228c).

In some embodiments, each condensing vessel is the same size. For example, first condenser 216a, second condenser 216b, and/or third condenser 216c can each be the same size. In some examples, each condensing vessel can match the largest sized condensing vessel. This can increase the versatility of the system, minimize the risk of blocking vapor flow with spray oil, and/or provide additional residence time in the condensing vessel.

In some embodiments, each condensing column can include a high-level alarm and/or low-level alarm. Each high-level alarm and/or low-level alarm can provide a set level that causes the condenser drain pump to engage or disengage. In some examples, each high-level and low-level alarm can be a ball float with an alarm. In some embodiments, each high-level and/or low-level alarm includes a sight glass (e.g., glass sight glass) to allow monitoring of each alarm, which can allow the operator to monitor if each alarm is operating correctly (e.g., monitor whether the ball float is stuck). For example, a sight glass can be positioned above the top ball float and a sight glass can be positioned below the bottom ball float. In some embodiments, the inlet and/or outlet of each condensing column can include a digital vacuum gage. Each digital vacuum gauge can monitor the vacuum (e.g., pressure), which can allow the operator to monitor and/or troubleshoot potential plugging of equipment (e.g., condenser 216, oil cooler 226, oil tank 228) and/or conduit (e.g., piping).

In some embodiments, the conduit exiting each condensing column can include a dust filtering apparatus (e.g., quick change screen, y-strainer). The dust filtering apparatus can inhibit (e.g., by screening) at least a portion of the solids from passing therethrough to limit the amount of solids entering the heat exchangers and/or storage tanks. In other words, the dust filtering apparatus reduces the amount of buildup in the heat exchangers and will keep the oil in the tanks at a higher temperature (e.g., hotter) such that it can be more easily pumped.

Each oil cooler 226 (e.g., 226a, 226b, 226c) (also referred to as a heat exchanger) further reduces the temperature of the condensed hydrocarbon vapor (e.g., oil) using an oil cooling heat exchanger. In some examples, the oil cooler 226 can reduce the temperature of the oil to approximately 120-degrees Fahrenheit. In some embodiments (as illustrated in FIG. 2), each oil cooler 226 receives condensed hydrocarbon vapor from the respective condenser 216 (e.g., 216a, 216b, 216c), as described previously. In other embodiments (not illustrated in FIG. 2), each oil cooler 226 receives condensed hydrocarbon vapor from the respective oil tank 228 (e.g., 228a, 228b, 228c). In some embodiments, the oil cooler 226 can be an indirect shell and tube style oil cooling heat exchanger, which can pump a circulating fluid (e.g., cooling fluid) therethrough to indirectly cool the oil. The circulating fluid can be an ethylene glycol/water mix (e.g., approximately 35% ethylene glycol and approximately 65% water) that is circulated and cooled through a fluid cooler 235 (e.g., closed loop evaporative circuit fluid cooler). In the oil cooler 226, the oil rejects heat and the circulating fluid absorbs heat, thereby reducing the temperature of the oil before it is discharged to the oil tank 228 (e.g., 228a, 228b, 228c).

Each oil tank 228 (e.g., 228a, 228b, 228c) stores the oil using an oil storage tank. In some embodiments (as illustrated in FIG. 2), each oil tank 228 receives condensed hydrocarbon vapor (e.g., oil) from each respective oil cooler 226 (e.g., 226a, 226b, 226c). In some embodiments (not illustrated in FIG. 2), each oil tank 228 receives condensed hydrocarbon vapor from each respective condenser 216 (e.g., 216a, 216b, 216c). Within the oil tank, at least a portion of any particulates in the oil can settle.

Then, a portion of the oil is recirculated (e.g., pumped) from the oil tank 228 to the condenser 216 which sprays the oil onto the hydrocarbon vapor entering the condenser 216, as described previously. In other words, the condenser 216 receives (and uses in its spray nozzles) a portion of the oil from the oil tank 228, which was produced within the system 200 by condensing vaporized hydrocarbons, such that the oil is recycled (recirculated) oil from within the system 200. In other words, oil that was condensed from the hot vapor is then used to condense additional hydrocarbon vapor into additional oil. Recycling oil in this manner may reduce the potential for contamination within the system 200, because introducing outside oil (from outside the system 200) into system 200 (rather than using oil produced within the system 200) may cause contamination.

A vacuum (also referred to as the vacuum fan), which is not shown in FIG. 2, can be configured to move the hydrocarbon vapor through the system 200. In some embodiments, the vacuum is positioned after the third condensing stage (e.g., downstream from the third condenser 216c) and includes a fan that provides a slightly greater force than the total combined pressure drop of each stage of equipment in the system 200 that processes hydrocarbon vapor (e.g., from the rotary retort 208 to the inlet piping of the vacuum fan). In some examples, the conduit between the third condenser 216c and the vacuum fan includes a condensation collector system (e.g., cow belly with a drain, p-trap with a drain) to capture any condensation between the final condenser and the vacuum fan. This capture of condensation will reduce the amount of fluid carryover from the final condenser into the vacuum fan. For example, the vacuum can pull the hydrocarbon vapor from an outlet of the rotary retort 208, through the dust remover 214, through the first condenser 216a, through the second condenser 216b, and through the third condenser 216c. In some embodiments, the vacuum includes a variable frequency drive (VFD) that can control the speed and suction of the vacuum. The VFD can modulate (e.g., adjust) the speed and suction depending on various (e.g., changing) operating conditions. Additionally, the vacuum can include an air inlet bypass valve installed in the piping directly before (e.g., upstream) of the fan inlet to provide inlet air in instances of system 200 shutdown or plugging.

Continuing with FIG. 2, and describing the configuration of the condensing stages illustrated in FIG. 2, the vapor processing subsystem 244 can include three condensing stages. The first condensing stage (e.g., heavy) includes a first condenser 216a, a first oil cooler 226a, and a first oil tank 228a. Similarly, the second condensing (e.g., medium) stage includes a second condenser 216b, a second oil cooler 226b, and a second oil tank 228b. Finally, the third condensing stage (e.g., light) includes a third condenser 216c, a third oil cooler 226c, and a third oil tank 228c. In some embodiments, each of the condensing stages can operate under different temperature ranges and flowrates as described herein.

Beginning with the first condenser 216a (e.g., vessel), the first condenser 216a receives hydrocarbon vapor (e.g., received from the dust remover 214) and also receives oil (e.g., received from the first oil tank 228a). In some examples, the outlet of the dust remover 214 is connected by a conduit to an inlet of the first condenser 216a, thereby establishing fluid communication between the dust remover 214 and the first condenser 216a, such that the first condenser 216a can receive hydrocarbon vapor from the dust remover 214. In some embodiments, the first condenser 216a can include a co-current flow design in which the first condenser 216a receives vapor (e.g., vapor enters the first condenser 216a) at or near its top and the first condenser 216a discharges vapor (e.g., vapor exits the first condenser 216a) at or near its bottom. In some embodiments, the flow rate of the vapor as it enters the first condenser 216a can be approximately 1,831 actual cubic feet per minute (ACFM). In some embodiments, the temperature of the vapor as it enters the first condenser 216a can be between approximately 600-degrees Fahrenheit and approximately 800-degrees Fahrenheit. In some examples, an outlet of the first oil tank 228a is connected by a conduit to an inlet of the first condenser 216a, thereby establishing fluid communication between the first oil tank 228a and the first condenser 216a, such that the first condenser 216a can receive oil from the first oil tank 228a. In this manner, the oil that the first condenser 216a receives from the first oil tank 228a is recycled (recirculated) oil from within the system 200 (e.g., produced by the system 200). Recycling oil may reduce the potential for contamination within the system 200, because introducing outside oil (from outside the system 200) into system 200 (rather than using oil produced within the system 200) may cause contamination.

Within the first condenser 216a, the oil is sprayed (e.g., via one or more spray nozzles) such that the hydrocarbon vapor comes into contact with the oil sprays, thereby using direct contact to reduce the temperature of the hydrocarbon vapor and cause at least a portion of the vapor to condense. In some embodiments, the first condenser 216a can include five spray levels. In some embodiments, the spray oil flow rate can be approximately 126 gallons per minute (GPM) at approximately 200 pounds per square inch gauge (psig). In some embodiments, the spray oil temperature can be approximately 120-degrees Fahrenheit.

Then, the first condenser 216a discharges the hydrocarbon vapor that condensed (e.g., oil) to the first oil cooler 226a and discharges the hydrocarbon vapor that did not condense (e.g., vapor) to the second condenser 216b. In some embodiments, the temperature of the vapor as it exits the first condenser 216a can be approximately 250-degrees Fahrenheit.

Turning to the first oil cooler 226a (e.g., heat exchanger), the first oil cooler 226a receives oil (e.g., received from the first condenser 216a) and also receives a circulating fluid (e.g., received from the fluid cooler 235), which can be, for example a cooling medium. In some examples, an outlet of the first condenser 216a is connected by a conduit to an inlet of the first oil cooler 226a, thereby establishing fluid communication between the first condenser 216a and the first oil cooler 226a, such that the first oil cooler 226a can receive oil from the first condenser 216a. In some embodiments, the temperature of the oil as it enters the first oil cooler 226a can be approximately 250-degrees Fahrenheit. In some embodiments, the oil flow rate through the first oil cooler 226a can be approximately 126 gallons per minute (GPM). In some examples, an outlet of the fluid cooler 235 is connected by a conduit to an inlet of the first oil cooler 226a, thereby establishing fluid communication between the fluid cooler 235 and the first oil cooler 226a, such that the first oil cooler 226a can receive a circulating fluid from the fluid cooler 235.

Within the first oiler cooler 226a, the oil rejects heat and the circulating fluid absorbs heat, thereby decreasing the temperature of the oil. For example, the first oil cooler 226a can be an indirect shell and tube style heat exchanger that indirectly exchanges heat between the oil and the circulating fluid. Because the temperature of the circulating fluid is lower temperature than the temperature of the oil, the oil rejects heat and the circulating fluid absorbs heat. Thus, the first oil cooler 226a causes the temperature of the oil to decrease and causes the temperature of the circulating fluid to increase. In some embodiments, the circulating fluid flow rate can be approximately 286 gallons per minute (GPM). In some embodiments, the cooling fluid can be a glycol/water blend. For example, the cooling fluid can include approximately 35% glycol and approximately 65% water.

Then, the first oiler cooler 226a discharges the oil to the first oil tank 228a and discharges the circulating fluid to the fluid cooler 235. In some embodiments, the temperature of the oil as it exits the first oiler cooler 226a can be approximately 120-degrees Fahrenheit.

Turning to the first oil tank 228a (e.g., oil storage tank), the first oil tank 228a receives oil (e.g., received from the first oil cooler 226a). In some examples, the outlet of the first oil cooler 226a is connected by a conduit to the inlet of the first oil tank 228a, thereby establishing fluid communication between the first oil cooler 226a and the first oil tank 228a, such that the first oil tank 228a can receive oil from the first oil cooler 226a. Within the first oil tank 228a, particulates in the oil can settle.

Then, the first oil tank 228a can discharge at least a portion of the oil to the oil scrubber 220 (which is discussed below) and can also discharge at least a portion of the oil to the first condenser 216a (as previously discussed). In this manner, the oil that is supplied to the first condenser 216a from the first oil tank 228a is recycled (recirculated) oil from within the system 200 (e.g., produced by the system 200). Recycling oil may reduce the potential for contamination within the system 200, because introducing outside oil (from outside the system 200) into system 200 (rather than using oil produced within the system 200) may cause contamination.

Turning now to the second condenser 216b (e.g., vessel), the second condenser 216b receives hydrocarbon vapor (e.g., received from the first condenser 216a) and also receives oil (e.g., received from the second oil tank 228b). In some examples, the outlet of the first condenser 216a is connected by a conduit to an inlet of the second condenser 216b, thereby establishing fluid communication between the first condenser 216a and the second condenser 216b, such that the second condenser 216b can receive hydrocarbon vapor from the first condenser 216a. In some embodiments, the second condenser 216b can include a counter-current flow design in which the second condenser 216b receives vapor (e.g., vapor enters the second condenser 216b) at or near its bottom and the second condenser 216b discharges vapor (e.g., vapor exits the second condenser 216b) at or near its top. In some embodiments, the flow rate of the vapor as it enters the second condenser 216b can be approximately 1,120 actual cubic feet per minute (ACFM). In some embodiments, the temperature of the vapor as it enters the second condenser 216b can be approximately 250-degrees Fahrenheit. In some examples, an outlet of the second oil tank 228b is connected by a conduit to an inlet of the second condenser 216b, thereby establishing fluid communication between the second oil tank 228b and the second condenser 216b, such that the second condenser 216b can receive oil from the second oil tank 228b. In this manner, the oil that the second condenser 216b receives from the second oil tank 228b is recycled (recirculated) oil from within the system 200 (e.g., produced by the system 200). Recycling oil may reduce the potential for contamination within the system 200, because introducing outside oil (from outside the system 200) into system 200 (rather than using oil produced within the system 200) may cause contamination.

Within the second condenser 216b, the oil is sprayed (e.g., via one or more spray nozzles) such that the hydrocarbon vapor comes into contact with the oil sprays, thereby using direct contact to reduce the temperature of the hydrocarbon vapor and cause at least a portion of the vapor to condense. In some embodiments, the second condenser 216b can include three spray levels. In some embodiments, the spray oil flow rate can be approximately 38 gallons per minute (GPM) at approximately 200 pounds per square inch gauge (psig). In some embodiments, the spray oil temperature can be approximately 120-degrees Fahrenheit.

Then, the second condenser 216b discharges the hydrocarbon vapor that condensed (e.g., oil) to the second oil cooler 226b and discharges the hydrocarbon vapor that did not condense (e.g., vapor) to the third condenser 216c. In some embodiments, the temperature of the vapor as it exits the second condenser 216b can be approximately 170-degrees Fahrenheit.

Turning to the second oil cooler 226b (e.g., heat exchanger), the second oil cooler 226b receives oil (e.g., received from the second condenser 216b) and also receives a circulating fluid (e.g., received from the fluid cooler 235), which can be, for example a cooling medium. In some examples, an outlet of the second condenser 216b is connected by a conduit to an inlet of the second oil cooler 226b, thereby establishing fluid communication between the second condenser 216b and the second oil cooler 226b, such that the second oil cooler 226b can receive oil from the second condenser 216b. In some embodiments, the temperature of the oil as it enters the second oil cooler 226b can be approximately 240-degrees Fahrenheit. In some embodiments, the oil flow rate through the second oil cooler 226b can be approximately 38 gallons per minute (GPM). In some examples, an outlet of the fluid cooler 235 is connected by a conduit to an inlet of the second oil cooler 226b, thereby establishing fluid communication between the fluid cooler 235 and the second oil cooler 226b, such that the second oil cooler 226b can receive a circulating fluid from the fluid cooler 235.

Within the second oil cooler 226b, the oil rejects heat and the circulating fluid absorbs heat, thereby decreasing the temperature of the oil. For example, the second oil cooler 226b can be an indirect shell and tube style heat exchanger that indirectly exchanges heat between the oil and the circulating fluid. Because the temperature of the circulating fluid is lower temperature than the temperature of the oil, the oil rejects heat and the circulating fluid absorbs heat. Thus, the second oil cooler 226b causes the temperature of the oil to decrease and causes the temperature of the circulating fluid to increase. In some embodiments, the circulating fluid flow rate can be approximately 52 gallons per minute (GPM). In some embodiments, the cooling fluid can be a glycol/water blend. For example, the cooling fluid can include approximately 35% glycol and approximately 65% water.

Then, the second oil cooler 226b discharges the oil to the second oil tank 228b and discharges the circulating fluid to the fluid cooler 235. In some embodiments, the temperature of the oil as it exits the second oil cooler 226b can be approximately 120-degrees Fahrenheit.

Turning to the second oil tank 228b (e.g., oil storage tank), the second oil tank 228b receives oil (e.g., received from the second oil cooler 226b). In some examples, the outlet of the second oil cooler 226b is connected by a conduit to the inlet of the second oil tank 228b, thereby establishing fluid communication between the second oil cooler 226b and the second oil tank 228b, such that the second oil tank 228b can receive oil from the second oil cooler 226b. Within the second oil tank 228b, particulates in the oil can settle.

Then, the second oil tank 228b can discharge at least a portion of the oil to the oil scrubber 220 (which is discussed below) and can also discharge at least a portion of the oil to the second condenser 216b (as previously discussed). In this manner, the oil that is supplied to the second condenser 216b from the second oil tank 228b is recycled (recirculated) oil from within the system 200 (e.g., produced by the system 200). Recycling oil may reduce the potential for contamination within the system 200, because introducing outside oil (from outside the system 200) into system 200 (rather than using oil produced within the system 200) may cause contamination.

Turning now to the third condenser 216c (e.g., vessel), the third condenser 216c receives hydrocarbon vapor (e.g., received from the second condenser 216b) and also receives oil (e.g., received from the third oil tank 228c). In some examples, the outlet of the second condenser 216b is connected by a conduit to an inlet of the third condenser 216c, thereby establishing fluid communication between the second condenser 216b and the third condenser 216c, such that the third condenser 216c can receive hydrocarbon vapor from the second condenser 216b. In some embodiments, the third condenser 216c can include a counter-current flow design in which the third condenser 216c receives vapor (e.g., vapor enters the third condenser 216c) at or near its bottom and the third condenser 216c discharges vapor (e.g., vapor exits the third condenser 216c) at or near its top. In some embodiments, the flow rate of the vapor as it enters the third condenser 216c can be approximately 819 actual cubic feet per minute (ACFM). In some embodiments, the temperature of the vapor as it enters the third condenser 216c can be approximately 170-degrees Fahrenheit. In some examples, an outlet of the third oil tank 228c is connected by a conduit to an inlet of the third condenser 216c, thereby establishing fluid communication between the third oil tank 228c and the third condenser 216c, such that the third condenser 216c can receive oil from the third oil tank 228c. In this manner, the oil that the third condenser 216c receives from the third oil tank 228c is recycled (recirculated) oil from within the system 200 (e.g., produced by the system 200). Recycling oil may reduce the potential for contamination within the system 200, because introducing outside oil (from outside the system 200) into system 200 (rather than using oil produced within the system 200) may cause contamination.

Within the third condenser 216c, the oil is sprayed (e.g., via one or more spray nozzles) such that the hydrocarbon vapor comes into contact with the oil sprays, thereby using direct contact to reduce the temperature of the hydrocarbon vapor and cause at least a portion of the vapor to condense. In some embodiments, the third condenser 216c can include three spray levels. In some embodiments, the spray oil flow rate can be approximately 225 gallons per minute (GPM) at approximately 200 pounds per square inch gauge (psig). In some embodiments, the spray oil temperature can be approximately 120-degrees Fahrenheit.

Then, the third condenser 216c discharges the hydrocarbon vapor that condensed (e.g., oil) to the third oil cooler 226c and discharges the hydrocarbon vapor that did not condense (e.g., vapor) to the gas flare/recycle 238. In some embodiments, the temperature of the vapor as it exits the second condenser 216b can be approximately 120-degrees Fahrenheit.

Turning to the third oil cooler 226c (e.g., heat exchanger), the third oil cooler 226c receives oil (e.g., received from the third condenser 216c) and also receives a circulating fluid (e.g., received from the fluid cooler 235), which can be, for example a cooling medium. In some examples, an outlet of the third condenser 216c is connected by a conduit to an inlet of the third oil cooler 226c, thereby establishing fluid communication between the third condenser 216c and the third oil cooler 226c, such that the third oil cooler 226c can receive oil from the third condenser 216c. In some embodiments, the temperature of the oil as it enters the third oil cooler 226c can be approximately 170-degrees Fahrenheit. In some embodiments, the oil flow rate through the third oil cooler 226c can be approximately 225 gallons per minute (GPM). In some examples, an outlet of the fluid cooler 235 is connected by a conduit to an inlet of the third oil cooler 226c, thereby establishing fluid communication between the fluid cooler 235 and the third oil cooler 226c, such that the third oil cooler 226c can receive a circulating fluid from the fluid cooler 235.

Within the third oil cooler 226c, the oil rejects heat and the circulating fluid absorbs heat, thereby decreasing the temperature of the oil. For example, the third oil cooler 226c can be an indirect shell and tube style heat exchanger that indirectly exchanges heat between the oil and the circulating fluid. Because the temperature of the circulating fluid is lower temperature than the temperature of the oil, the oil rejects heat and the circulating fluid absorbs heat. Thus, the third oil cooler 226c causes the temperature of the oil to decrease and causes the temperature of the circulating fluid to increase. In some embodiments, the circulating fluid flow rate can be approximately 200 gallons per minute (GPM). In some embodiments, the cooling fluid can be a glycol/water blend. For example, the cooling fluid can include approximately 35% glycol and approximately 65% water.

Then, the third oil cooler 226c discharges the oil to the third oil tank 228c and discharges the circulating fluid to the fluid cooler 235. In some embodiments, the temperature of the oil as it exits the third oil cooler 226c can be approximately 120-degrees Fahrenheit.

Turning to the third oil tank 228c (e.g., oil storage tank), the third oil tank 228c receives oil (e.g., received from the third oil cooler 226c). In some examples, the outlet of the third oil cooler 226c is connected by a conduit to the inlet of the third oil tank 228c, thereby establishing fluid communication between the third oil cooler 226c and the third oil tank 228c, such that the third oil tank 228c can receive oil from the third oil cooler 226c. Within the third oil tank 228c, particulates in the oil can settle.

Then, the third oil tank 228c can discharge at least a portion of the oil to the oil scrubber 220 (which is discussed below) and can also discharge at least a portion of the oil to the third condenser 216c (as previously discussed). In this manner, the oil that is supplied to the third condenser 216c from the third oil tank 228c is recycled (recirculated) oil from within the system 200 (e.g., produced by the system 200). Recycling oil may reduce the potential for contamination within the system 200, because introducing outside oil (from outside the system 200) into system 200 (rather than using oil produced within the system 200) may cause contamination.

Turning now to the oil scrubber 220, the oil scrubber 220 receives oil from the system 200 (e.g., oil that the system 200 produced by vaporizing hydrocarbons and then condensing the vaporized hydrocarbons). For example, the oil scrubber 220 can receive at least a portion of the oil from the first oil tank 228a, at least a portion of the oil from the second oil tank 228b, and/or at least a portion of the oil from the third oil tank 228c. In some examples, an outlet of the first oil tank 228a is connected by a conduit to the inlet of the oil scrubber 220, thereby establishing fluid communication between the first oil tank 228a and the oil scrubber 220, such that the oil scrubber 220 can receive oil from the first oil tank 228a. In some examples, an outlet of the second oil tank 228b is connected by a conduit to the inlet of the oil scrubber 220, thereby establishing fluid communication between the second oil tank 228b and the oil scrubber 220, such that the oil scrubber 220 can receive oil from the second oil tank 228b. In some examples, an outlet of the third oil tank 228c is connected by a conduit to the inlet of the oil scrubber 220, thereby establishing fluid communication between the third oil tank 228c and the oil scrubber 220, such that the oil scrubber 220 can receive oil from the third oil tank 228c.

Within the oil scrubber 220, the oil scrubber 220 processes the oil into a useable product, such that the oil can be used in a variety of applications. The oil scrubber 220 can remove free water, asphaltenes and other solids, and any other undesirable compounds (e.g., sulfur, ammonia) from the oil such that the oil can be used. In some instances, the oil scrubber 220 can include a sulfur reduction process to reduce the sulfur content (e.g., wt %) of the oil. For example, the sulfur reduction process can include a chemical treatment (e.g., a sulfur scavenger) that reduces the sulfur content of the oil. Thus, in short summary of the system 200, the system 200 (e.g., the solids processing subsystem 242) processes feedstock 202 to produce vaporized hydrocarbons and solid char. The system 200 (e.g., the vapor processing subsystem 244) processes the vaporized hydrocarbons to produce oil, which is a useful product.

Then, the oil scrubber 220 can discharge the useable oil (e.g., discharged to the marketplace), hydrocarbon vapor (e.g., discharged to the gas flare/recycle 238), and/or water (e.g., discharged to the stripping column 230). The oil scrubber 220 discharges the useable oil, such that it can be used in the marketplace (e.g., the oil can be used in a variety of applications). In some embodiments, the oil can be trucked away from the site of the system 200, pumped to another location, etc. In other embodiments, at least a portion of the useable oil can be used at the site of the system 200. For example, useable oil can be used as fuel in the rotary retort 208 (e.g., oil-fired rotary retort 208). As another example, at least a portion of the useable oil can be used as fuel in a separate burner (e.g., oil-fired burner), which can be used to heat rotary retort 208. As another example, at least a portion of the useable oil can be used as fuel in a generator (e.g., electrical generator), which can be used to provide electricity for the system 200. The oil scrubber 220 discharges the hydrocarbon vapor (e.g., uncondensed hydrocarbon vapor) to the gas flare/recycle 238. In some examples, an outlet of the oil scrubber 220 is connected by a conduit to an inlet of the gas flare/recycle 238, thereby establishing fluid communication between the oil scrubber 220 and the gas flare/recycle 238, such that the gas flare/recycle 238 can receive hydrocarbon vapor from the oil scrubber 220. The oil scrubber 220 discharges the water (which may include ammonia and/or hydrogen sulfide) into the stripping column 230. In some examples, an outlet of the oil scrubber 220 is connected by a conduit to the inlet of the stripping column 230, thereby establishing fluid communication between the oil scrubber 220 and the stripping column 230, such that the stripping column 230 can receive water from the oil scrubber 220. In other examples, instead of treating the water onsite, the water can be shipped out for offsite processing and/or disposal.

Turning now to the fluid cooler 235, the fluid cooler 235 receives circulating fluid (e.g., cooling medium, cooling fluid) from the system 200. For example, the fluid cooler 235 can receive circulating fluid (e.g., the return for the circulating fluid) from the first oil cooler 226a, the second oil cooler 226b, and/or the third oil cooler 226c. In some embodiments, the circulating fluid can be a glycol/water blend (e.g., approximately 35% glycol and approximately 65% water). In some examples, an outlet of the first oil cooler 226a is connected by a conduit to an inlet of the fluid cooler 235, thereby establishing fluid communication between the first oil cooler 226a and the fluid cooler 235, such that the fluid cooler 235 can receive circulating fluid from the first oil cooler 226a. In some examples, an outlet of the second oil cooler 226b is connected by a conduit to an inlet of the fluid cooler 235, thereby establishing fluid communication between the second oil cooler 226b and the fluid cooler 235, such that the fluid cooler 235 can receive circulating fluid from the second oil cooler 226b. In some examples, an outlet of the third oil cooler 226c is connected by a conduit to an inlet of the fluid cooler 235, thereby establishing fluid communication between the third oil cooler 226c and the fluid cooler 235, such that the fluid cooler 235 can receive circulating fluid from the third oil cooler 226c.

Within the fluid cooler 235, the fluid cooler 235 reduces the temperature of the circulating fluid. For example, the fluid cooler 235 can be a closed loop evaporative circuit fluid cooler. The fluid cooler 235 removes heat from the circulating fluid, thereby reducing the temperature of the circulating fluid. The fluid cooler 235 can also receive water (e.g., make-up water) from the water supply 236. In some examples, an outlet of the water supply 236 is connected by a conduit to an inlet of the fluid cooler 235, thereby establishing fluid communication between the water supply 236 and the fluid cooler 235, such that the fluid cooler 235 can receive water from the water supply 236.

After reducing the temperature of the circulating fluid, the fluid cooler 235 discharges the circulating fluid to the oil coolers 226 (e.g., 226a, 226b, 226c), such that the oil coolers 226 receive the circulating fluid as previous described. In other words, the temperature of the circulating fluid is reduced in the fluid cooler 235 before the circulating fluid is discharged to the oil coolers 226 (e.g., supply of circulating fluid to the oil coolers 226). Then, as previously described, the oil coolers 226 receive the circulating fluid and, in the oil coolers 226, the temperature of the circulating fluid is increased (e.g., the circulating fluid absorbs heat and the oil rejects heat) before the circulating fluid is discharged to the fluid cooler 235 (e.g., return of circulating fluid to the fluid cooler 235).

The system 200 can include one or more temperature gauges (not shown in FIG. 2) to monitor the temperature of the circulating fluid. As non-limiting examples, temperature gauges can be included at the inlets to the oil coolers 226 (e.g., 226a, 226b, 226c), at the outlets to the oil coolers 226 (e.g., 226a, 226b, 226c), at the inlet to the fluid cooler 235, and/or at the outlet to the fluid cooler 235. Additionally, the system can include one or more pumps (not shown) to pump the circulating fluid. Moreover, the system 200 can be configured to adjust the speed of the one or more pumps to increase or decrease the flowrate of the circulating fluid to provide a desired temperature of the of the circulating fluid, such as the temperature at the inlets to the oil coolers 226 (e.g., 226a, 226b, 226c)

FIG. 3 illustrates one instance of an oil production system 300. The system 300 includes many of the same features as the system 100 in FIG. 1 and/or the system 200 in FIG. 2. Due to the similar features, the reference numbers and the description for the system 100 in FIG. 1 and the system 200 in FIG. 2 are also applicable to the system 300 in FIG. 3; however, the reference numbers in FIG. 3 are 300 series rather than 100 series or 200 series. As described below, the system 300 in FIG. 3 may include one or more features may be different than the features previously described for the system 100 in FIG. 1 and/or the system 200 in FIG. 2.

In one instance, the hopper 304 may be loaded in a single batch so that the hopper 304 inlet may be sealed (i.e., after loading the feedstock 302) to prevent outside oxygen from becoming entrained in the feedstock 302. The system 300 may process only the one batch of feedstock 302 loaded into the hopper 304 and may not run continuously between multiple batches. However, the components within the system 300 may run continuously during the processing of that one batch.

A nitrogen tank 303 may store nitrogen gas and may supply nitrogen gas to the hopper 304 to be used as a purge gas within the hopper 304. An outlet of the nitrogen tank 303 may be connected by a conduit (purge line) to an inlet of the hopper 304, thereby establishing fluid communication between the nitrogen tank 303 and the hopper 304.

The rotary kiln 308 may be electrically heated, as previously discussed. In one instance, the rotary kiln 308 may include a 10-kW resistive heater.

A first condenser 316 may be a shell and tube style heat exchanger. For example, the shell may contain a circulating fluid, which is used as the cooling medium, and the tube or tubes contain the hydrocarbon vapor. The circulating fluid may be, for example, water. In one instance, the first condenser 316 receives the circulating fluid (e.g., water) at an inlet to the first condenser 316 (e.g., into the shell) from the second condenser 318. In other words, an outlet from the second condenser 318 may be connected by a conduit to an inlet of the first condenser 316, thereby establishing fluid communication between the second condenser 318 and the first condenser 316. Additionally, the first condenser 316 receives hydrocarbon vapor at an inlet to first condenser 316 (e.g., into the tube). The circulating fluid has a lower temperature than the hydrocarbon vapor within the first condenser 316 and, as a result, the hydrocarbon vapor rejects heat and the circulating fluid absorbs heat. Such temperature reduction may condense a portion of the hydrocarbon vapor from a heated vapor state into a liquid oil state.

The first condenser 316 may discharge liquid oil and hydrocarbon vapor to the first oil collector 324 (e.g., oil collection #1). In other words, an outlet from the first condenser 316 may be connected by a conduit to the inlet of the first oil collector 324. The first oil collector 324 may collect the liquid oil and discharge hydrocarbon vapor.

The first condenser 316 may discharge the circulating fluid to the water supply 336. The system 300 may include a temperature gauge (not shown in FIG. 3) to monitor the temperature of the circulating fluid at the outlet of the first condenser 316. The system 300 may be configured to adjust the speed of the pump (not shown) to increase or decrease the flowrate of water to provide a desired temperature of the water within the first condenser 316.

A second condenser 318 may be a shell and tube style heat exchanger. For example, the shell may contain a circulating fluid, which is used as the cooling medium, and the tube or tubes contain the hydrocarbon vapor. The circulating fluid may be, for example, water. In one instance, the second condenser 318 receives the circulating fluid (e.g., water) at an inlet to the second condenser 318 (e.g., into the shell) from the water supply 336. In other words, an outlet from the water supply 336 may be connected by a conduit to an inlet of the second condenser 318, thereby establishing fluid communication between the water supply 336 and the second condenser 318. Additionally, the second condenser 318 receives hydrocarbon vapor at an inlet to second condenser 318 (e.g., into the tube) from the first oil collector 324. The circulating fluid has a lower temperature than the hydrocarbon vapor within the second condenser 318 and, as a result, the hydrocarbon vapor rejects heat and the circulating fluid absorbs heat. Such temperature reduction may condense a portion of the hydrocarbon vapor from a heated vapor state into a liquid oil state.

The second condenser 318 may discharge liquid oil and non-condensable vapor to the second oil collector 322 (e.g., oil collection #2). In other words, an outlet from the second condenser 318 may be connected by a conduit to the inlet to the second oil collector 322. The second oil collector 322 may collect the liquid oil and discharge non-condensable vapor.

The second condenser 318 may discharge the circulating fluid to the first condenser 316 (as previously described). The system 300 may include a temperature gauge (not shown in FIG. 3) to monitor the temperature of the circulating fluid at the outlet of the second condenser 318. The system 300 may be configured to adjust the speed of the pump to increase or decrease the flowrate of water to provide a desired temperature of the water within the second condenser 318.

The water supply 336 may include a tank that stores, cools, and supplies the circulating fluid. In one instance, the circulating fluid may be water and, accordingly, the tank may be a water tank. The water tank may include an ice bath to reduce the temperature of the water therein. A pump may be configured to supply the water to various components in the system 300. For example, the water supply 336 may supply water to the second condenser 318 (as previously described). After the water flows through the second condenser 318 and the first condenser 316, the water supply 336 may receive the water from the first condenser 316. In other words, an outlet from the from the first condenser 316 may be connected by a conduit to an inlet of the water supply 336.

A vac pump 337 may be configured to pull non-condensable vapor through an outlet of the second oil collector 322. The vac pump 337 may pull the hydrocarbon vapor through the vapor outlet of the rotary kiln 308 and through the components of the system 300 that further process the hydrocarbon vapor (e.g., dust remover 314, first condenser 316, first oil collector 324, second condenser 318, and second oil collector 322). For example, the vac pump 337 may be a light vacuum operating at a pressure less than ½-inch of water column. In one instance, the vac pump 337 receives the non-condensable vapor from the second oil collector 322. In other words, an outlet of the second oil collector 322 may be connected by a conduit to the inlet of the vac pump 337, thereby establishing fluid communication between the second oil collector 322 and the vac pump 337. The vac pump 337 may discharge the non-condensable vapor to a flare gas discharge 338.

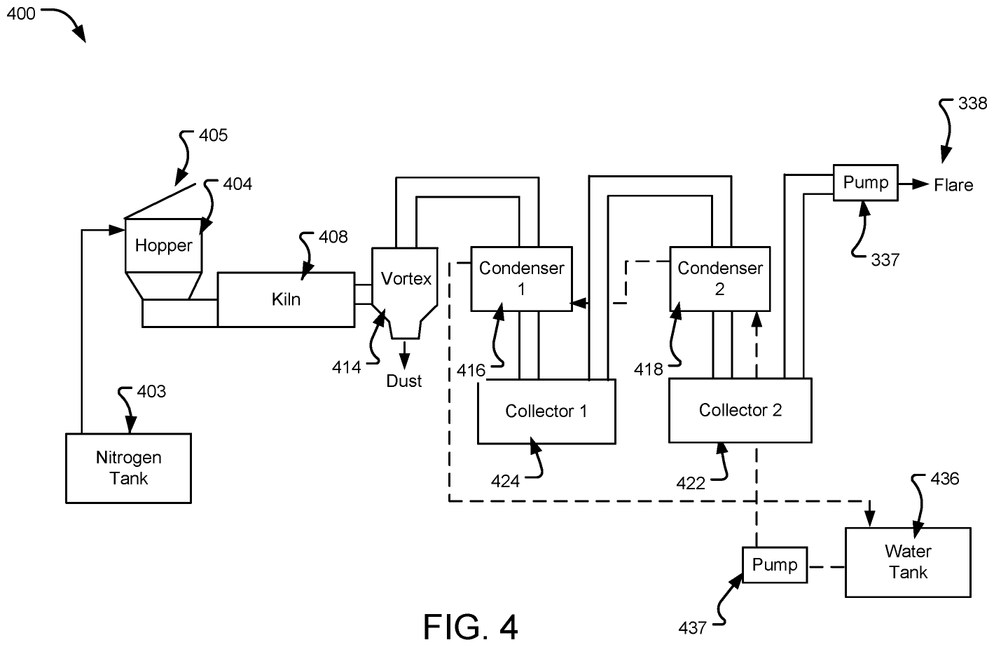

FIG. 4 illustrates one instance of an oil production system 400. The system 400 includes many of the same features as the system 300 in FIG. 3. Due to the similar features, the reference numbers and the description for the system 300 in FIG. 3 are also applicable to the system 400 in FIG. 4; however, the reference numbers in FIG. 4 are 400 series rather than 300 series.

Additionally, FIG. 4 illustrates a lid 405 on the hopper 404. The lid 405 may seal the hopper 404 inlet (i.e., the inlet to load the feedstock) with respect to ambient air after the feedstock is loaded into the hopper 404. In other words, the lid 405 may be opened to load feedstock into the hopper 404. Then, after the feedstock is loaded into the hopper 404, the lid 405 may be closed. In one instance, the lid 405 may be hydraulically actuated to open and close the lid 405.

Additionally, FIG. 4 illustrates a water pump 437 to supply water from the water supply 436 (e.g., water tank) to the second condenser 418. After the water flows through the second condenser 418 and the first condenser 416, the water supply 436 may receive the water from the first condenser 416. In other words, the water pump 437 circulates water through the system 400.

The foregoing merely illustrates the principles of the invention. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the invention and are thus within the spirit and scope of the present invention. From the above description and drawings, it will be understood by those of ordinary skill in the art that the particular embodiments shown and described are for purposes of illustrations only and are not intended to limit the scope of the present invention. References to details of particular embodiments are not intended to limit the scope of the invention.

While the invention has been described with respect to specific examples including presently preferred modes of carrying out the invention, those skilled in the art will appreciate that there are numerous variations and permutations of the above-described systems and techniques. It is to be understood that other embodiments may be utilized and structural and functional modifications may be made without departing from the scope of the present invention. Thus, the spirit and scope of the invention should be construed broadly as set forth in the appended claims.

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment”, “an embodiment”, “an aspect,” or “one instance” means that a particular feature, structure, or characteristic described in connection with the embodiment is included in at least one embodiment of the disclosure. The appearances of the phrase “in one embodiment” or “in one instance” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### EXAMPLES

As previously discussed, the system can process feedstock (e.g., coal, biomass-based material, rubber, plastics, nutshells) to produce char and oil. The char and oil can be useful products and/or can be further processed to produce useful products.

Laboratory testing was performed on oil that was produced by processing tire feedstock in an example system, as described below in Example 1. Additionally, laboratory testing was performed on coal feedstock and the resulting char produced by an example system, as described below in Example 2. Finally, laboratory testing was performed on syngas, including non-condensable vapor, produced by an example system, as described in Example 3.

### Example 1—Oil Produced from Tire Feedstock

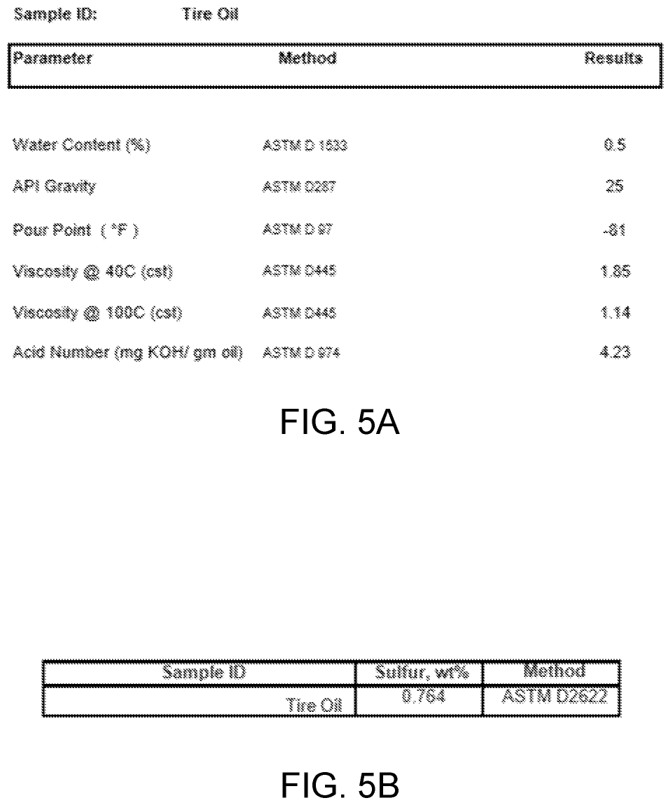

FIGS. 5A-5B illustrate the results of a laboratory analysis performed on oil produced from tires (i.e., tire feedstock) input into an example system for processing. The tires were processed using an example system similar to the system illustrated in FIG. 4. The laboratory results include the API gravity of the oil and the sulfur content (e.g., % wt) of the oil.

Processing tire feedstock produced oil having an API gravity of 25, as illustrated in FIG. 5A. In general, oil having a relatively higher API is more valuable than oil having a relatively lower API. In some instances, crude oil contains an API gravity between 25 API gravity and 40 API gravity. As illustrated in FIG. 5A, the oil produced from tires contained 25 API gravity, which demonstrates that the system can process tires to produce oil having an API gravity within a typical range for crude oil.

Processing tire feedstock produced oil having a sulfur content of 0.764% wt, as illustrated in FIG. 5B. In general, “sweet” oil has a sulfur content of less than 0.5-percent, whereas “sour” oil has a sulfur content of greater than 2.0-percent. Generally, oil having a relatively lower sulfur content (e.g., “sweet” oil) is more valuable than oil having a relatively higher sulfur content (e.g., “sour” oil). As illustrated in FIG. 5B, the oil produced from tires contained a sulfur content of 0.764% wt, which demonstrates that the system can process tires to produce oil having a relatively lower sulfur content than “sour” oil. In some embodiments, a sulfur reduction process (e.g., a sulfur scavenger) can be used to further reduce the sulfur content of the oil.

### Example 2—Coal Feedstock and Char Produced from the Coal Feedstock

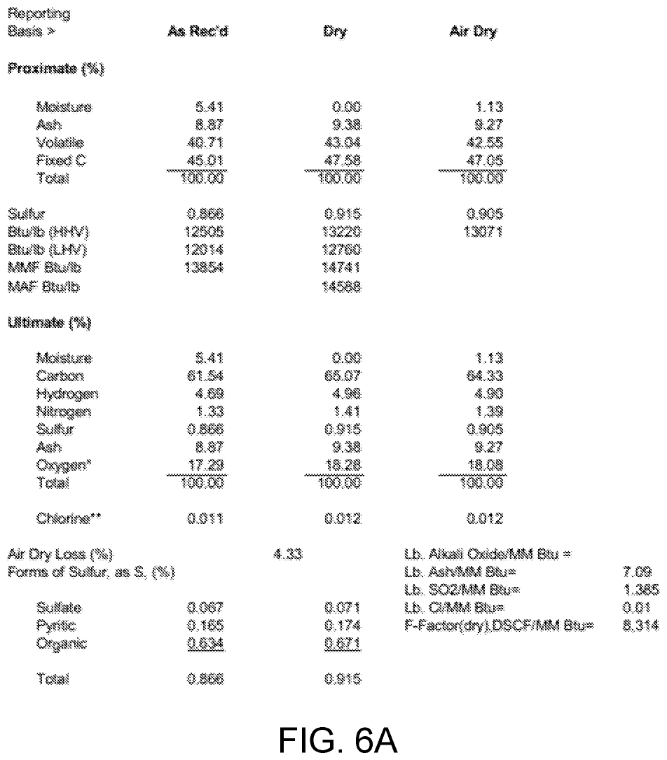

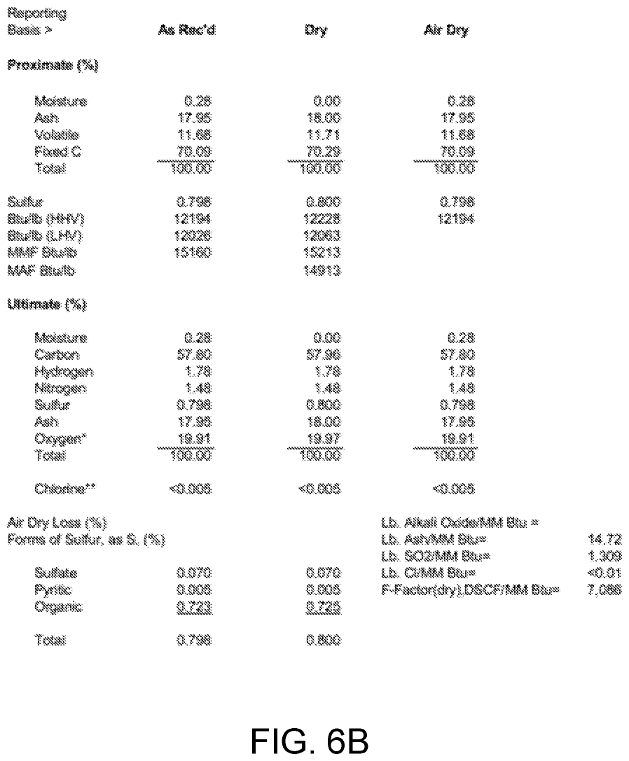

FIGS. 6A-6B illustrate the results of laboratory analysis performed on coal feedstock (as illustrated in FIG. 6A) prior to processing in an example system and the resulting char (as illustrated in FIG. 6B) after processing the coal in the system. As previously discussed, the system can process feedstock (e.g., coal) to produce oil and char, which are useful products.

FIGS. 6A-6B illustrate that processing the coal into char reduces the volatile proximate (%). As illustrated in FIG. 6A, the coal feedstock, before processing, contained approximately 40.71 to 43.04 volatile %. As illustrated in FIG. 6B, the char, produced after processing the coal feedstock, contained approximately 11.68 to 11.71 volatile %. Such reduction in volatile %, by processing the coal into char, reduces the ability for coal to pollute. In other words, the char is cleaner than the coal, such that the char can be more reusable than the coal feedstock. For example, the cleaner char can have expanded uses over the coal, such as activated carbon, agricultural carbon, and to provide for cleaner burning in power plants, among other uses.

### Example 3—Syngas Produced by System

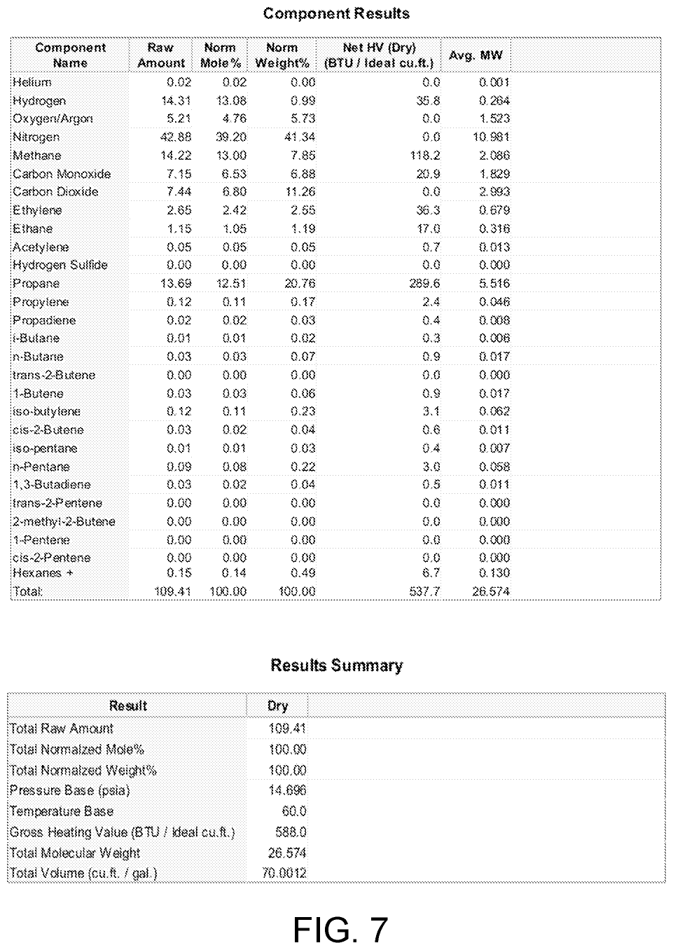

FIG. 7 illustrates the results of laboratory analysis performed on syngas, or synthesis gas, produced by an example system. The syngas includes the non-condensable vapor produced by the system, which, as previously discussed, can include natural gas (e.g., propane, methane, and/or ethane). FIG. 7 illustrates that syngas produced by the system included propane, methane, and butane. The natural gas can be routed back to the system, such that it can be used as fuel by the system (e.g., fuel for the rotary retort) as previously discussed. Recycling or otherwise reusing natural gas in this manner can reduce the need to purchase natural gas (e.g., from a pipeline network, from the grid).

What is claimed is:

1. A system for producing oil from feedstock containing hydrocarbons, the system comprising:
one or more condensers receiving a vapor containing hydrocarbons and receiving an oil, the oil cooling the vapor within the one or more condensers such that at least a portion of the vapor condenses into oil; and
one or more recirculation loops to supply at least a portion of oil condensed in the one or more condensers to the one or more condensers.

2. The system of claim 1, further comprising:
the one or more condensers comprising a first condenser, a first inlet of the first condenser receiving the vapor that contains hydrocarbons, a second inlet of the first condenser receiving a first portion of oil, the first portion of oil cooling the vapor such that a first portion of the vapor condenses into the first portion of oil, a first outlet of the first condenser discharging the first portion of oil, a second outlet of the first condenser discharging a second portion of the vapor;
a first oil cooler in fluid communication with the first condenser, a first inlet of the first oil cooler receiving the first portion of oil from the first outlet of the first condenser, the first oil cooler reducing a temperature of the first portion of oil, a first outlet of the first oil cooler discharging the first portion of oil; and
a first oil tank in fluid communication with the first oil cooler, an inlet of the first oil tank receiving the first portion of oil from the first outlet of the first oil cooler, a first outlet of the first oil tank discharging the first portion of oil into a first recirculation loop of the one or more recirculation loops such that the first recirculation loop supplies the first portion of oil to the first condenser.

3. The system of claim 2, further comprising:
the one or more condensers comprising a second condenser, a first inlet of the second condenser receiving the second portion of the vapor from the second outlet of the first condenser, a second inlet of the second condenser receiving a second portion of oil, the second portion of oil cooling the second portion of vapor such that a third portion of the vapor condenses into the second portion of oil, a first outlet of the second condenser discharging the second portion of oil, a second outlet of the second condenser discharging a fourth portion of the vapor;
a second oil cooler in fluid communication with the second condenser, a first inlet of the second oil cooler receiving the second portion of oil from the first outlet of the second condenser, the second oil cooler reducing the temperature of the second portion of oil, a first outlet of the second oil cooler discharging the second portion of oil; and
a second oil tank in fluid communication with the second oil cooler, an inlet of the second oil tank receiving the second portion of oil from the first outlet of the second oil cooler, a first outlet of the second oil tank discharging the second portion of oil into a second recirculation loop of the one or more recirculation loops such that the second recirculation loop supplies the second portion of oil to the second condenser.

4. The system of claim 3, further comprising:
the one or more condensers comprising a third condenser, a first inlet of the third condenser receiving the fourth portion of the vapor from the second outlet of the second condenser, a second inlet of the third condenser receiving a third portion of oil, the third portion of oil cooling the fourth portion of vapor such that a fifth portion of the vapor condenses into the third portion of oil, a first outlet of the third condenser discharging the third portion of oil, a second outlet of the third condenser discharging a sixth portion of the vapor;
a third oil cooler in fluid communication with the third condenser, a first inlet of the third oil cooler receiving the third portion of oil from the first outlet of the third condenser, the third oil cooler reducing the temperature of the third portion of oil, a first outlet of the third oil cooler discharging the third portion of oil; and
a third oil tank in fluid communication with the third oil cooler, an inlet of the third oil tank receiving the third portion of oil from the first outlet of the third oil cooler, a first outlet of the third oil tank discharging the third portion of oil into a third recirculation loop of the one or more recirculation loops such that the third recirculation loop supplies the third portion of oil to the third condenser.

5. The system of claim 1, wherein the one or more condensers comprise a first condenser and a second condenser, the system comprising:
the first condenser, a first inlet of the first condenser receiving the vapor that contains hydrocarbons, a second inlet of the first condenser receiving a first portion of light oil, the first portion of light oil cooling the vapor, the first condenser condensing a first portion of the vapor into a first portion of heavy oil, a first outlet of the first condenser discharging a second portion of the vapor, a second outlet of the first condenser discharging the first portion of heavy oil;
the second condenser in fluid communication with the first condenser, a first inlet of the second condenser receiving the second portion of the vapor from the first outlet of the first condenser, a second inlet of the second condenser receiving a second portion of light oil, the second portion of light oil cooling the second portion of the vapor, the second condenser condensing a third portion of the vapor into a second portion of heavy oil and a mixture of light oil and water, a first outlet of the second condenser discharging a non-condensable portion of the vapor, a second outlet of the second condenser discharging the second portion of heavy oil, and a third outlet of the second condenser discharging a mixture of light oil and water;
a separator in fluid communication with the second condenser, an inlet of the separator receiving the mixture of light oil and water from the third outlet of the second condenser, the separator separating the mixture of light oil and water into light oil and water, a first outlet of the separator discharging the water, a second outlet of the separator discharging the light oil; and
the one or more recirculating loops supplying the first portion of light oil to the first condenser and the second portion of light oil to the second condenser, wherein the first portion of light oil and the second portion of light oil each include at least one of at least a portion of the first portion of heavy oil, at least a portion of the second portion of heavy oil, or at least a portion of the light oil.

6. The system of claim 5, further comprising a tank, the tank in fluid communication with the first condenser such that the tank receives at least a portion of the first portion of heavy oil from the first condenser, the tank in fluid communication with the second condenser such that the tank receives at least a portion of the second portion of heavy oil from the second condenser, the tank in fluid communication with the separator such that the tank receives at least a portion of the light oil from the separator, an outlet of the tank supplying the first portion of light oil to the first condenser and the second portion of light oil to the second condenser.

7. The system of claim 5, wherein the first condenser further comprises a third inlet receiving a circulating fluid from a cooling unit, wherein the vapor rejects heat and the circulating fluid absorbs heat in the first condenser, and a third outlet discharging the circulating fluid to the cooling unit.

8. The system of claim 7, wherein the cooling unit is a cooling tower, the cooling tower receiving a cooling fluid, the circulating fluid rejecting heat and the cooling fluid absorbing heat in the cooling tower.

9. The system of claim 8, wherein the circulating fluid is oil and the cooling fluid is water, wherein the cooling tower evaporates the water.

10. The system of claim 9, wherein the first condenser is configured to reduce a temperature of the vapor to between approximately 250-degrees Fahrenheit and 300-degrees Fahrenheit.

11. The system of claim 5, wherein the second condenser further comprises:
the first inlet located near a bottom of the second condenser;
a plurality of spray nozzles within the second condenser and located above the first inlet, the plurality of spray nozzles in fluid communication with the second inlet, wherein the plurality of spray nozzles receive the second portion of light oil and spray the second portion of light oil inside the second condenser;
a tray within the second condenser, wherein the tray receives and collects the mixture of light oil and water; and
the second outlet located near the bottom of the second condenser.

12. The system of claim 11, wherein the second condenser is configured to reduce a temperature of the second portion of the vapor to between approximately 200-degrees Fahrenheit and 249-degrees Fahrenheit.

13. The system of claim 5, further comprising:
a hopper, an inlet of the hopper receiving the feedstock, an outlet of the hopper discharging the feedstock, wherein a lid removably seals the inlet of the hopper with respect to ambient air;
a feed screw in communication with the hopper, a first end of the feed screw receiving the feedstock from the outlet of the hopper, the feed screw supplying the feedstock to a second end of the feed screw;
a retort in communication with the feed screw, an inlet of the retort receiving the feedstock from the second end of the feed screw, the retort heating the feedstock until a first portion of the feedstock vaporizes into the vapor and a second portion of the feedstock is a solid mass, a first outlet of retort discharging the vapor, a second outlet of the retort discharging the solid mass; and
a particle remover in fluid communication with the retort, an inlet of the particle remover receiving the vapor from the first outlet of the retort, the particle remover removing particles from the vapor, an outlet of the particle remover discharging the vapor, wherein the first inlet of the first condenser receives the vapor.

14. The system of claim 13, wherein the outlet of the hopper includes a valve to limit air flow through the outlet of the hopper, wherein the inlet of the retort includes a seal to limit air flow through the inlet of the retort, wherein the first outlet of the retort includes a seal to limit air flow through the first outlet of the retort, wherein the second outlet of the retort includes a seal to limit air flow through the second outlet of the retort.

15. The system of claim 13, wherein the hopper receives a purge gas, wherein the purge gas includes the non-condensable portion of the vapor.

16. The system of claim 15, wherein the hopper is in fluid communication with the second condenser, the hopper inlet receiving the non-condensable portion of the vapor from the first outlet of the second condenser.

17. The system of claim 5, further comprising a gas flare in fluid communication with the second condenser, a first inlet of the gas flare receiving the non-condensable portion of the vapor from the third outlet of the second condenser, the gas flare burning the non-condensable portion of the vapor.

18. The system of claim 17, further comprising a stripping column in fluid communication with and between the separator and the gas flare, an inlet of the stripping column receiving water from the separator, the stripping column using steam and chemicals to treat the water, an outlet of the stripping column discharging evaporates to the gas flare.

19. A method for producing oil from feedstock containing hydrocarbons, the method comprising:
receiving a vapor that contains hydrocarbons and receiving an oil into a one or more condensers;
cooling the vapor with the oil in the one or more condensers to condense at least a portion of the vapor into oil; and
recirculating at least a portion of the oil condensed in the one or more condensers to the one or more condensers.

20. A method for producing oil from feedstock containing hydrocarbons, the method comprising:
receiving a vapor that contains hydrocarbons and receiving a first portion of light oil into a first condenser;
cooling the vapor with the first portion of light oil and condensing a first portion of the vapor into a first portion of heavy oil in the first condenser;
discharging a second portion of the vapor and the first portion of heavy oil from the first condenser;
receiving the second portion of the vapor and a second portion of light oil into a second condenser;
cooling the second portion of vapor with the second portion of light oil and condensing a third portion of the vapor into a second portion of heavy oil in the second condenser;
discharging a non-condensable portion of the vapor, the second portion of heavy oil, and a mixture of light oil and water from the second condenser;
separating the mixture of light oil and water into light oil and water, discharging the light oil from a separator; and
supplying the first portion of light oil to the first condenser and the second portion of light oil to the second condenser.

21. The method of claim 20, further comprising receiving a circulating fluid in the first condenser, wherein the vapor rejects heat and the circulating fluid absorbs heat in the first condenser.

22. The method of claim 21, further comprising cooling the vapor to a temperature between approximately 250-degrees Fahrenheit and 300-degrees Fahrenheit within the first condenser.

23. The method of claim 20, further comprising collecting a mixture of light oil and water on a tray within the second condenser.

24. The method of claim 21, further comprising cooling the second portion of the vapor to a temperature between approximately 200-degrees Fahrenheit and 249-degrees Fahrenheit within the second condenser.

25. The method of claim 20, further comprising:
receiving the feedstock in a hopper, the hopper including a lid that removably seals hopper with respect to ambient air;
supplying a purge gas to the hopper, wherein the purge gas includes the non-condensable portion of the vapor;
supplying the feedstock to a retort;
heating the feedstock until a first portion of the feedstock vaporizes into a vapor and a second portion of the feedstock is a solid mass; and
removing particles from the vapor.

26. The method of claim 25, wherein the hopper receives the non-condensable portion of the vapor from the second condenser.
